(19) United States
(12) Patent Application Publication
(10) Pub. No.: US 2020/0005295 A1
(43) Pub. Date: Jan. 2, 2020

(54) SECURE LOCATION BASED ELECTRONIC FINANCIAL TRANSACTION METHODS AND SYSTEMS

(71) Applicant: JEAN LOUIS MURPHY, OTTAWA (CA)

(72) Inventor: JEAN LOUIS MURPHY, OTTAWA (CA)

(21) Appl. No.: 16/484,548

(22) PCT Filed: Feb. 12, 2018
(86) PCT No.: PCT/CA2018/000025

§ 371 Date: Aug. 8, 2019

Related U.S. Application Data
(60) Provisional application No. 62/457,343, filed on Feb. 10, 2017.

(51) Int. Cl. G06Q 20/40; G06Q 20/12

(52) U.S. Cl. CPC G06Q 20/40; G06Q 20/12

(57) ABSTRACT

Mobile payments to Point-of-Sale (PoS) terminals, kiosks, vending systems etc. as well as mobile banking are increasingly common due to the electronic devices available. However, fraud is an ongoing issue. Embodiments of the invention support increased security by applying processes which allow for easy and secure development of financial transaction services and equipment. Accordingly, the location of the consumer performing the financial transaction is included within the process. Embodiments include a consumer being physically present to authorise irrespective of authorisation of their credentials, a consumer may establish preferred locations for transactions, a retailer and consumer may perform the transaction once the consumer has left the retail location through stored location data of the user's device. Embodiments of the invention also support financial transactions without a direct PoS transaction as the user's device and the PoS terminal broker the transaction in the cloud using location data.

### CROSS-REFERENCE TO RELATED APPLICATIONS

This application claims the benefit of priority from Patent Cooperation Treaty Application PCT/CA2018/000025 filed Feb. 12, 2018 entitled “Secure Location Based Electronic Financial Transaction Methods and Systems” which itself claims priority from U.S. Provisional Patent Application No. 62/547,343 filed Feb. 10, 2017, the entire contents of each are incorporated herein by reference.

### FIELD OF THE INVENTION

This invention relates to transactions and more particularly to methods and systems for facilitating secure electronic financial transactions and secure information transactions without linking the electronic devices.

### BACKGROUND OF THE INVENTION

The cost reductions, footprint reductions, etc. offered by semiconductor manufacturing techniques in microprocessors, organic light emitting diodes (OLEDs), wireless transceivers, and charge coupled devices (CCDs) have led to today's ubiquitous consumer electronics. Over the same period wireless and wired telecommunications networks have established ubiquitous connectivity of these consumer electronic devices, including, but not limited to, smartphones, laptops, tablets, smartwatches, fitness trackers, navigation systems, gaming systems, and entertainment systems to a wide range of services and enterprises hosted on remote servers. This overall network and its servers are commonly referred to as the Internet.

By 2020 the number of smartphones is expected to exceed 6 billion, used by approximately 70% of the global population, with wireless interfaces, Internet access, and data services with high definition displays, integral camera(s), global positioning system (GPS), multiple sensors (accelerometer, temperature, and humidity for example), as well as wired and wireless audio interfaces. However, these will still represent only approximately 25% of the total number of wirelessly connected devices in use by the global population at that time where many of these other devices will perform tasks undertaken on smartphones today.

Amongst the plethora of applications for such wirelessly connected devices are mobile payments (financial transactions using an “electronic wallet” application) to Point-of-Sale (PoS) terminals, kiosks, vending systems etc. as well as the provisioning of mobile banking where the user can perform a wide range of financial activities through a web interface (commonly known as being “online”) on their portable wirelessly connected device such as laptop or smartphone. Accordingly, these intelligent and mobile computing and wireless connected devices are now part of evolving financial and commercial ecosystems that are merging with these devices already existing information gathering and processing capabilities.

Accordingly, an array of multi-national corporations and organizations such as Apple™ Google™, Samsung™, MasterCard™ etc. are all vying to democratize paying for goods and services with either their electronic devices or software applications yet control and exploit the information acquired as a result which is personalized lifestyle information for each buyer. This process has not gone unhindered however, since multiple obstacles exist some which are beyond the reach of their control. For example, the possibility of performing a Near-Field-Communication (NFC) payments is not dictated by the buyer s device, but by the PoS terminal which is requesting the transaction on the merchant-side of the transaction. In January 2016 only 20% of all operated NFC-capable PoS terminals in Canada had the functionality enabled and by the end of 2016 whilst 90% of European and North American shipped new PoS terminals were NFC-enabled this figure drops to 75% globally. Even by 2020 it is expected that globally only 77% of PoS terminals will be NFC enabled despite annual shipments of 90 million PoS terminals. A major factor in these market figures is the growth of micro-PoS (mPoS) terminals.

Another major hurdle for NFC payments is consumer reluctance/hesitation which arises from both a lack of knowledge pertaining to both the technology and the security which supports an NFC transaction and the populist media highlighting how NFC debit/credit cards can be easily read even whilst in the user's pocket or handbag. There are also factors such as user age and familiarity to visually seeing, holding and presenting their payment cards before and during a transaction. Accordingly, the unfamiliar gesture of presenting their mobile device to another computing device might seem strange enough to become a deterrent to adopt these new payment methods. Furthermore, cellphone manufacturers must also adapt their device to be able to perform more powerful and diverse NFC data transactions due to, but not limited to, security concerns, the cost implied in the constant re-configuration of device hardware and the possibility that consumer adoption is simply too slow to justify the costs of implementation.

Accordingly, it would be beneficial to provide original equipment manufacturers (OEMs), software providers, service providers, financial institutions etc. with a method and process supporting democratization functions such as mobile payments by applying a process which allows for easy and secure development of financial transaction services and equipment within an environment where ubiquitous connectivity is becoming a standard feature of everyday life. It would be beneficial with respect to the prior art to provide a process that allows for simple and secure connectivity between devices coupled to a network to facilitate the broader democratization of financial transaction technologies such as mobile-to-fixed and mobile-to-mobile technologies.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to transactions and more particularly to methods and systems for facilitating secure electronic financial transactions and secure information transactions without linking the electronic devices.

In accordance with an embodiment of the invention there is provided a method of authorizing a financial transaction comprising:
establishing via a remote server the presence of an authorizer of the financial transaction (FT) within a predetermined threshold with respect to a geolocation associated with a requester of the financial transaction; wherein
the financial transaction comprises at least one transaction process (TPr); and
either the authorizer may be a requestee seeking to perform the financial transaction or a requested seeking to establish authorization of the financial transaction; or
the authorizer may be a requestee seeking to establish authorization the financial transaction or a requested seeking to perform the financial transaction.

In accordance with an embodiment of the invention there is provided a method of authorizing a financial transaction comprising authorizing an electronic transaction based upon establishing via a remote server the presence of an authorizer of the electronic transaction within a predetermined threshold with respect to a geolocation associated with a requester of the electronic transaction.

In accordance with an embodiment of the invention there is provided a method of authorizing a financial transaction comprising establishing via a remote server the presence of an authorizer of the financial transaction within a predetermined threshold with respect to a geolocation associated with a requester of the financial transaction.

In accordance with an embodiment of the invention there is provided a method of authorizing a financial transaction comprising authorizing an electronic transaction at a remote system absent direct communications between a requesting device and an authorizing device based upon establishing at least a match between an identity of a plurality of identities each relating to an authorized system within a predetermined geolocation threshold of a current geolocation of the requesting device and an identity of the requesting device relating to an electronic transaction with respect to a geolocation associated with a requester of the electronic transaction.

In accordance with an embodiment of the invention there is provided a system for authorizing a financial transaction comprising authorizing an electronic transaction at a remote system absent direct communications between a requesting device and an authorizing device based upon establishing at least a match between an identity of a plurality of identities each relating to an authorized system within a predetermined geolocation threshold of a current geolocation of the requesting device and an identity of the requesting device relating to an electronic transaction with respect to a geolocation associated with a requester of the electronic transaction.

In accordance with an embodiment of the invention there is provided a method of authorizing a financial transaction comprising:
authorizing an electronic transaction based upon establishing via a remote server the presence of an authorizer of the electronic transaction within a predetermined threshold with respect to a geolocation associated with a requester of the electronic transaction; wherein
the geolocation is established for at least one of the authorizer and the requester in dependence upon verifying that acquired image content provided by the at least one of the authorizer and the requester is associated with the geolocation.

In accordance with an embodiment of the invention there is provided a system for authorizing a financial transaction comprising:
a remote server for authorizing an electronic transaction based upon establishing the presence of an authorizer of the electronic transaction within a predetermined threshold with respect to a geolocation associated with a requester of the electronic transaction; wherein
the geolocation is established for at least one of the authorizer and the requester in dependence upon verifying that acquired image content provided by the at least one of the authorizer and the requester is associated with the geolocation.

In accordance with an embodiment of the invention there is provided a method of authorizing a financial transaction comprising:
receiving first data relating to a requestee seeking to establish the authorization;
receiving second data relating to a requested seeking to authorize the financial transaction;
processing the first data and second data with at least one machine learning process or a plurality of machine learning processes to establish whether an authorization may be issued;
storing the result of the determination within a blockchain.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts an exemplary process flow according to an embodiment of the invention relating to establishing geolocation-based database within an authorizing device;

FIGS. 4 and 5 depict an exemplary process relating to establishing an association between a requesting device and authorizing device via a remote system according to an embodiment of the invention;

FIG. 6 depicts an exemplary message flow relating to establishing a user's registration with a remote system according to an embodiment of the invention;

FIG. 7 depicts an exemplary message flow relating to establishing a requesting device's registration with a remote system according to an embodiment of the invention;

FIG. 8 depicts an exemplary message flow relating to establishing a transaction with a requesting device via a remote system based upon a user selecting the requesting device upon their authorizing device according to an embodiment of the invention; and

FIG. 9 depicts an exemplary message flow relating to establishing a transaction upon remote system based upon transaction and location data from requesting device and authorizing device.

### DETAILED DESCRIPTION

The present invention is directed to transactions and more particularly to methods and systems for facilitating secure electronic financial transactions and secure information transactions without linking the electronic devices.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “device” as used herein and throughout this disclosure, refers to an assembly of components and elements of mechanical and/or electronic hardware either discretely or in combination with at least one of firmware and software employed to perform or execute one or more tasks or functions as determined either by its configuration or its firmware and/or software programming. Accordingly, a device may include but not be limited a portable electronic device, a fixed electronic device, a wearable device, a computer server, a computing device, a computer or other devices supporting and/or executing embodiments of the invention.

A “portable electronic device” (PED) or “mobile electronic device” (commonly referred to as a mobile) as used herein and throughout this disclosure, refers to a device used for communications and other applications that requires a battery or other independent form of energy for power. A PED may be recharged from a fixed interface to obtain power and also be connected to one or more of a wired communications interface, a wireless communications interface (e.g. radio frequency, microwave, and acoustic) and an optical communications interface. This includes devices, but is not limited to, such as a cellular telephone, smartphone, personal digital assistant (PDA), portable computer, pager, portable multimedia player, portable gaming console, a navigation system, laptop computer, tablet computer, a wearable device, an implanted device, a smart card, portable PoS, mobile PoS (mPoS), a motorized vehicle, a non-motorized vehicle, public transit vehicle, a vehicle guided by tracks and/or rails, an aircraft, a lighter-than-air device, a drone, a robot, an android, a biomedical device, an item of medical equipment and an electronic reader.

A “fixed electronic device” (FED) as used herein and throughout this disclosure, refers to a device used for communications and other applications that requires connection to a fixed interface to obtain power. A fixed electronic device may be connected to one or more of a wired communications interface, a wireless communications interface (e.g. radio frequency, microwave, and acoustic) and an optical communications interface. This includes, but is not limited to, a laptop computer, a personal computer, a computer server, a kiosk, a terminal, a gaming console, a digital set-top box, a base station, a wireless network access node/point, a network device, an automated teller machine (ATM), an automated banking machine (ABM), an analog set-top box, an Internet enabled appliance, an Internet enabled television, a PoS, a vending machine, a self-service device or system, a robotic system, an item of medical equipment, an entertainment system and a multimedia player.

A “computer server” or “server” as used herein, and throughout this disclosure, refers to one or more physical computers co-located and/or geographically distributed running one or more services as a host to users of other computers, servers, PEDs, FEDs, etc. to serve the client needs of these other users. This includes, but is not limited to, a database server, file server, mail server, print server, web server, gaming server, virtual environment server, utility provider server, service provider server, goods provider server, financial server, financial registry server, personal server, and a Government regulatory server. A server may comprise a combination of hardware and software in order to serve information over a network, or a multitude of networks. A server may be a virtual instance of a server (such as a virtual machine), a dedicated instance of a server (e.g. a motherboard hosting a single server), a computer, or a device.

A “processor” (also referred to as a microprocessor) as used herein, and throughout this disclosure, refers to a processor or coprocessor forming part of a computing device which processes information and performs mathematical calculations, in binary electronic form (bits) or quantum form (so called qubits). A processor or co-processor may optionally be a general processing unit, or it may be targeted at more specific aspects of a computing device, FED, PED etc. such as a Core Processing Unit (CPU), Graphical Processing Unit (GPU) or CoProcessing Unit (CoPU). Further examples of processors and/or coprocessors (CoPU) may include, but not be limited to, gyroscopes, neural network processors and/or coprocessors, so called “Always On” coprocessors employed to maintain functions when a device is in an “inactive state” or “sleep mode”, machine learning processors and/or coprocessors, etc.

A “network” as used herein, and throughout this disclosure, refers to a combination of devices such as computing devices, PEDs, and/or FEDs for example, which are interconnected. Such a network may internal to an entity (e.g. an enterprise, retailer, user, device or third party), external to an entity (e.g. an enterprise, retailer, user, device or third party), or a combination thereof. A network may be accessible to users without credentials, with credentials (e.g. user information such as username, password etc.) or provide different functionality to those with and without credentials etc. Examples of such networks include, but are not limited to, wireless networks, local area networks, metropolitan area networks, global networks, public networks, private networks an Internet Network (commonly referred to as the Internet but actually a combination of networks), wired networks, optical networks, telecommunications networks, data networks, etc.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED, FED and/or server.

A “medium” as used herein may refer to, but is not limited to, an intervening element supporting the transfer of data, information, electronic content, or other signals over a particular distance, network or networks. A medium accordingly may include, but not be limited to, a wireless medium, a physical medium or a shared medium. A “wireless medium” as used herein may refer to, but is not limited to, any means of communication exploiting the transmittal and/or receipt of information between devices using unguided signals, microwave signals, RF signals, acoustic signals or free-space optical signals. A “physical medium” as used herein may refer to, but is not limited to, any means of communication exploiting the transmittal and/or receipt of information between devices through a non-wireless medium using guided signals, confined signals such as electrical signals within an electrical conductor, optical signals within an optically transmissive medium at the wavelength of the optical signals, etc. A “shared medium” refers to a wireless medium or physical medium wherein information transferred serves multiple users. Examples of shared media include broadcasting, electrical multiplexing, optical multiplexing, etc.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook™, Google+™ Tumblr™ and Twitter™; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility provider, a financial provider and a service provider. Such enterprises may be directly owned and controlled by a company or may be owned and operated by a franchisee under the direction and management of a franchiser.

A “service provider” as used herein may refer to, but is not limited to, a third-party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of service providers, members of a financial registry, members of utility providers, members of retailers, members of organizations, members of charities, men, women and children. In its broadest sense the user may further include, but not be limited to, software systems, mechanical systems, electronic systems, devices, portable electronic devices, fixed electronic devices, robotic systems, android systems, etc. that may be characterised by an ability to exploit one or more embodiments of the invention either in terms of receiving and/or generating at least one of information, commands, or other electronic content via one or more networks and/or interfaces or capable of autonomously acting in an unsupervised manner. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“User information” as used herein may refer to, but is not limited to, user behavior information, user profile information, and personal information. It may also include a user's biometric information, an estimation of the user's biometric information, or a projection/prediction of a user's biometric information derived from current and/or historical biometric information, and current—historical profile information.

A “wearable computer device” (WCD) (also known as a “wearable device” or “wearable sensor”) relates to electronic devices that are worn or affixed to by the user including those under, within, with or on top of clothing or those that are inserted into, implanted into or attached to the user's body or are associated with the user and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, or motion sensors. In its broadest sense it may include devices associated with the user such as a motor vehicle, kitchen utensils, manufacturing equipment, tools, etc.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List of file formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities.

A “subscription” as used herein and through this disclosure refers to, but is not limited to, a financial transaction. This includes, but is not limited to, annual contracts, fixed term contracts, pay-per-use activities, etc. A purchase may be considered within embodiments of the invention as a subscription with a single occurrence.

A “financial registry” as used herein and through this disclosure refers to, but is not limited to, a database of customer and/or subscriber information relating to finances including, but not limited to, financial instruments such as credit cards, debit cards, and gift cards for example; financial services such as loans, mortgages, and banking for example; and financial accounts such as those relating to checking, savings, mortgage, line of credit, shares, and Government regulated savings.

A “registered party” as used herein may refer to a person, group, or organization that has registered with a financial registry and may or may not be the intended recipient of monies or intended provider of monies associated with a financial transaction.

A “financial provider” as used herein may refer to any provider of financial services, either online and/or in a traditional physical location including, but not limited to, credit, debit, and loan services against which financial charges are made arising from periodic and/or aperiodic transactions relating to a user and/or registered party.

An “External World” as used herein and through this disclosure refers to, but is not limited to, an environment within which a transaction between a user and a wares provider and/or service provider is executed resulting in a financial commitment between the user and the wares provider and/or service provider on a discrete and/or recurring basis with respect to the provisioning of at least one of a ware, wares, goods, a good, a product, products, a service, and services to the user by the wares provider and/or service provider. Accordingly, the “External World” includes, but is not limited to, servers, systems, and equipment relating to at least one of the wares provider(s), service provider(s), and financial provider(s) storing and managing aspects of the associated provider including, but not limited to, financial registries, service registries, user registries, security registries, credential registries, user registries, service agreements, service level agreements, and contracts. The “External World” may also include, but is not limited to, systems and equipment relating to the user including, but not limited to, PED(s) and FED(s) to which wares and/or services are provided.

A “financial transaction” or “transaction” as used herein and through this disclosure refers to, but is not limited to, an exchange for at least one of goods and/or services in exchange for remuneration, typically, financial remuneration in one or more currencies.

“Electronic Business” (e-business) as used herein and through this disclosure refers to, but is not limited to, any kind of business or commercial transaction that includes sharing information across the Internet. E-business may include, but is not limited to, P2P, C2B, B2B, C2G, and B2G.

A “person-to-person” (P2P) transaction or business model refers to transactions and/or business between one person to another person or alternatively between two entities each selected from the group comprising an organism, a person, a consumer, a user, an android and an autonomous robotic system. P2P transactions are also part of a wider known class of transactions known as “customer-to-customer” (C2C) transactions.

A “consumer-to-business” (C2B) transaction or business model refers to transactions and/or business between a consumer (individual) and a business wherein the transaction may be from the consumer to the business or from the business to the consumer. Accordingly, it refers to one or more transactions wherein one participant is considered a consumer, and the other a corporate or merchant entity.

A “business-to-business” (B2B) transaction or business model refers to transactions and/or business between a first business and a second business wherein the transaction may be from the first business to the second business or from the second business to the first business.

A “consumer-to-government” (C2G) and/or “business-to-government” (B2G) transaction or business model refers to transactions and/or business between a consumer (individual) or a business and a government wherein the transaction may be from the consumer/business to the government or from the government to the business and/or consumer. Accordingly, it refers to one or more transactions wherein one participant is considered a consumer or corporate/merchant entity and the other is a government entity.

A “person-to-device” (P2D) and/or “device-to-device” (D2D) transaction or business model refers to transactions and/or business between a person (individual) and a device or a first device and a second device respectively. The transaction may be from either party to the other as a discrete transaction or as part of a series of transactions.

“Geolocation” as used herein refers to, but is not limited, to the identification or estimation of the real-world geographic location of an object. In its simplest form geolocation involves the generation of a set of geographic coordinates and is closely related to the use of positioning systems, such as global positioning systems (GPS). However, other non-satellite-based systems may be employed including for example geolocating or positioning based upon a location engine exploiting wireless/radio frequency (RF) location methods such as Time Difference of Arrival (TDOA) where such information is accessible from multiple wireless transponders to allow triangulation. Alternatively, wireless base stations/cell towers can be employed to triangulate the approximate position through timing/power information of the multiple wireless base stations/cell towers which whilst subject to many sources of error beneficially supports indoor environments as well as outdoor environments where GPS satellite signals are weak or blocked. Other geolocation methods can include Internet and computer geolocation by associating a geographic location with the Internet Protocol (IP) address, MAC address, RFID, Wi-Fi access node etc. IP address location data can include information such as country, region, city, postal/zip code, latitude, longitude and time zone. Geolocation data may be defined in international standards such as ISO/IEC 19762-5:2008 or as defined by other standards or proprietary formats.

A “Requesting Device” (also known as an “RD” or “requestee”) as used herein refers to, but is not limited, to a device exploiting or supporting embodiments of the invention which initiates a given task or function (ToF). Within embodiments of the invention the RD may be the only requesting device or a plurality of devices which must all approve the executing of a specific ToF. With multiple devices comprising the RD they each receive communications and results relating to the ToF.

A “Managing Device” (MD) as used herein refers to, but is not limited, to a device exploiting or supporting embodiments of the invention which handles an initiated task. Accordingly, an MD may be the device which handles the completion of the task, a device according to embodiment of the invention whilst also being the device which forwards the task's result to the relevant devices, is the device which updates a database or file with the task's result, is a device executing a method of the invention, a device or devices managing the execution of a given ToF whilst fulfilling one or more methods of the invention.

An “Authorizing Device” (AD) as used herein refers to, but is not limited, to a device exploiting or supporting embodiments of the invention which determines whether a ToF can, should or will be executed and/or completed. Accordingly, an MD may include, but not be limited to, a MD, or multiple MDs, an RD, and the RD.

A “Financial Services Device” (FSD) as used herein refers to, but is not limited to a device providing financial services only. Accordingly, a FSD may be an automatic teller machine (ATM), a Point-of-Sale terminal, and a financial instrument card reader.

A “Secure Element (SecE1)” as used herein refers to, but is not limited, to a device exploiting or supporting embodiments of the invention refers to any device or portion of a device that allows for the storage of sensitive information of a device's owner or user, the storage of tokenized or encrypted information according to a method or embodiment of the invention, the storage of system-supplied sensitive information identifiers or keys according to a method or embodiment of the invention, and the storage of commonly used user identifiers for services offered over a network, the Internet or the device.

An “Information Route” (INR) as used herein refers to, but is not limited, to a device exploiting or supporting embodiments of the invention refers to various mediums that information must, will be, or can be transferred over in order to support communication from a device to one or more other devices. In various versions of this invention, the INR can be a single homogenous medium such as a physical or wireless medium or a hybrid INR (HINR), where information will, can or must be transferred over a heterogeneous route. A HINR may include for example, but not be limited to, when a user transfers account information from their smartphone first over a cellular network, which is then transmitted from a receiving tower over a physical medium such as an Ethernet cable to a routing centralized server, which is then transferred to a database for housing over fiber optic cable. An example of a Homogeneous INR may include for example, but not be limited to, when a computer transfers data to an external hard drive over a copper data transfer and power-supply cable through a USB port.

A “Modular Functionality Device” (MFD) as used herein refers to, but is not limited, to a device exploiting or supporting embodiments of the invention which serves a given, or a given set of functions, which when affixed to or worn by a user, grants that user the ability to execute those functions. Inherently, by dissociating the device with the user, the user loses the ability to execute said functions.

An “Augmented Reality Device” (ARD) as used herein refers to, but is not limited, to wearable computing device which allows a user to view content acquired by the ARD or generated, acquired, provided by a computer that is otherwise obstructed by said device, or not within the immediate vicinity of a user, on a viewing area that is part of the device which allows viewing by being transparent through the obstructing surface, makes the obstructed content visible by capturing the obstructed content with an image capturing device, and projecting the captured view onto the viewing area, or can provide a graphical user interface over the viewing area.

A “Virtual Reality Device” (VRD) as used herein refers to, but is not limited, to a wearable computing device which allows a user to view content acquired by the ARD or generated, acquired, provided by a computer that provides an immersive environment to the user.

A “vehicle” as used herein refers to, but is not limited, to a mechanized or non-mechanized means of transporting items, users, persons, animals etc. or it can transport nothing. A vehicle may include, but not be limited to, a motorcar, a truck, a bus, a train, a tram, a magnetically levitated vehicle, a bicycle, a motorcycle, a helicopter, an unmanned aerial vehicle (drone), an aircraft, a rocket, and a robot. Such vehicles may be controlled or piloted which can be piloted from inside the vehicle by a user or another user, from outside the vehicle by a user or another user, remotely from the vehicle by the user or another user, or they may be autonomous wherein the vehicle processes data in order to achieve motion etc. Within the description below in respect of embodiments of the invention, claims etc. reference to a vehicle may include the physical vehicle itself, a computer associated with the vehicle or the controller of the vehicle.

A “Fixed Service Computer” (FSC) as used herein refers to, but is not limited, to a computing device or computer which serves either a specific, or a given set of utilities and, or functions all the while usually being dedicated to a specific location in order to maximize its functionality. For example, a FSC may include, but not be limited to, a self-service kiosk, a self-serve gas pump at a gas station, a point of sale system, a vending machine, an automated check-out kiosk, and an automated teller machine.

A “Point of Sale” (POS) system or device as used herein refers to, but is not limited, to a computing device which manages or handles either, some or all of, the state of a transaction, an initiation of a transaction, and a settlement of a transaction wherein the transaction may be associated with a merchant, retailer, financial institution etc. A POS may be physical or virtual such a “checkout” within a web portal, webpage, or website. An FSC may provide a POS or it may incorporate within its functions those of a POS. For example, a clothing terminal which allows a given customer to browse for clothing items and save their preferred selection on a wish list, but that also allows this customer to purchase the desired items directly on the terminal.

A Payee's Payment Interface (PPI) as used herein refers to, but is not limited, to a system which usually receives user-input, payment information, or payment data of a legal person which represents financial information (FI) and then handles that FI in either a pre-determined, or anticipated set of functions. A PPI can, in some versions of the invention perform some or all of the following connect/serve the FI to a payment processing network, connect/serve the FI to a network-based server which will house the FI in a database, connect/serve the FI to a POS, connect/serve the FI to a network-based server in order to house the FI in a database alongside an identifier which can identifier the owner for the FI and serve the FI and process payments over a network. Accordingly, within embodiments of the invention the PPI may be, but not be limited to, a MFD to a POS, a MFD to a POS which is a FSC, a feature of a software or computer program, a network, a server, a mobile device, an application on a PED, device or FED, a feature or function of an application on a PED, device or FED, a website, a feature of a PED, Device, or FED, a MFD of a vehicle, be associated with a vehicle or user, be an application associated with an operating system of a vehicle, be a dedicated function of an operating system of a vehicle, or be a PED, device, or FED permanently or temporarily associated with a vehicle directly or support an embodiment of the invention as claimed.

A “screen”, “viewing area”, “display” or “graphical user interface” (GUI) as used herein refers to, but is not limited, to a display, portion of a display, or content presented upon a display allowing a user to view electronic content displayed upon it and/or select options and perform tasks based upon selecting an option via a haptic interface wherein the option is presented to the user. A screen, viewing area, display or GUI may be incorporated within a PED, device or FED or it may be associated with a PED, device or FED by an interface such as a wired interface, wireless interface, the Internet, etc. A screen, viewing area, display or GUI may be associated with audio, visual or audiovisual recording hardware or reproduction hardware, user authentication hardware and/or sensors, and proximity-sensing hardware. Such hardware may be integrated with the screen, viewing area, display or GUI or be associated with the screen, viewing area, display or GUI.

“User Authentication Hardware” (UAH) as used herein refers to, but is not limited, to any sensor, interface, PED, device, FED, MFD, etc. which obtains information with respect to authenticating the user upon the system to which the UAH is connected or associated. Accordingly, a UAH may include one or more of a biometric sensor, a magnetic card reader, a card reader, a pin pad, and a keyboard. Accordingly, a UAH may acquire a user's biometric data, user provided data, geolocation data, or credential information.

“Financial Information” (FI) as used herein refers to, but is not limited, to data association with a financial service provider, a financial transaction, a POS transaction, a user, a user's payment method(s), bank account(s), credit card information, debit card information, financial data stored within a PED, device or FED relating to a user or any sequence of data which corresponds or is associated to a person's financial assets, holdings, transactions etc.

“Gathered Data” (GD) as used herein refers to, but is not limited, to data that is collected with an intended purpose and may include, but not be limited to, financial information, biometric data, electronic content, and user data. For example, GD may include a list of GPS coordinates identifying the user's location over time, a user's search history, data extracted from one or more SOCNETs or SOMEs the user is registered with, data extracted from email, etc.

A “Local Source of Data” (LSD) as used herein refers to, but is not limited, to data stored within a memory, database, file system or memory unit associated with a device connected to a network to which the requesting device is connected, or on the requesting device itself.

A “Remote Source of Data” (RSD) as used herein refers to, but is not limited, to refers to data stored within a memory, database, housed in a database, filesystem or memory unit situated outside of the network to which a device is connected or outside the device concerned. Examples of an RSD may include, but not be limited to, a cloud-based database, a network attached storage (NAS) Server, and a cache file system hosted on a home network.

A “Nearby Source of Data” (NSD) as used herein refers to, but is not limited, to an RSD that is not present on any integrated memory unit of the requesting device, but which is accessible on the same Local Area Network (LAN) or that can only be accessed if a requesting device is within close proximity of the data source. Examples may include, but not be limited to, an external hard-drive and another computer coupled to the device via a Wi-Fi network.

“Baseline Data” (BD) as used herein refers to, but is not limited, to data that is used to associate provided data or information to an identifiable source. Comparison information can within embodiments of the invention be within computer-readable form, machine readable data, in visual form, in audio form, human-readable data, non-human-interpretable data, within an LSD, within an RSD, within a NSD, or other form according to embodiments of the inventions.

“Location-Based Authentication” (LAuth) or “Local Geolocation Data (LGD) as used herein refers to, but is not limited, to a process wherein a device allows its user to authenticate and allow an anticipated function of the device to be performed by utilizing the location of the user as a factor of the authentication. Embodiments of the invention may exploit LAuth/LGD, geolocation data, GPS coordinates derived by a device, GPS coordinates supplied by the user, GPS coordinates supplied by the device performing authentication via a GPS interface and system which is accessible by the device, or a combination thereof. Within other embodiments of the invention the LAuth data may include, but not be limited to, data acquired from a LSD, a RSD, a NSD, or a description of landmarks within the user's vicinity. Where a description is provided this may be achieved within embodiments of the invention by capturing a visual image of the surroundings, a user providing a computer readable description of the surroundings, a user providing audio input which is processed, extrapolating information acquired using a mathematical process locally or remotely.

Within other embodiments of the invention LAuth data may be obtained from one or more location specific identifiers supplied to the authentication system employed by the device where the identifier(s) may be acquired from other devices emitting the identifier(s) over short-range frequencies, are produced by interpreting two-dimensional or three-dimensional graphical information with a mathematical algorithm, a LSD, a RSD, a NSD. Within embodiments of the invention LAuth data may be compared or correlated to a set of BD of the same nature in order to produce mathematically relevant result of comparison. Within other embodiments of the invention a comparison based upon LAuth/LGD may define whether the LGD corresponds to a set of BD which is used to identify a specific location, the LGD corresponds to a set of BD which describes a set of locations, or that the LGD has been gathered in a system-deduced valid way. The BD employed within such a comparison may originate from one or more of a combination of LSD, RSD and NSD.

Within embodiments of the invention LAuth/LGD data may be processed with one or more mathematical algorithms to establish correlation wherein the correlation may be performed, for example, on the requesting device itself, on a nearby device which is in proximity of the requesting device, on a remote device which is not connected to the network of the requesting device. Within embodiments of the invention the LAuth/LGD correlation results may themselves be transposed to another method which would then update the BD with the LGD should the algorithm(s) produce a positive result. Within embodiments of the invention the processing of information with the mathematical algorithm may be performed on a CoPU as well as on a device's CPU.

Within embodiments of the invention according to the result of the authentication may enable the device, enable the user, enable the device and user, disable the device, disable the user, or disable the device and user with respect to the ToF that required authentication. This authentication may be combined with one or more other forms of authentication or it may be employed discretely. Within other embodiments of the invention the authentication may execute an automated, pre-programmed, anticipated or result-dependent ToF. Optionally, authentication may exploit one or more machine learning algorithms to automate aspects of the processes according to embodiments of the invention.

“Known-To-User Data” (KTU) as used herein refers to, but is not limited, to a data that is considered to only known to or known to exist by the owner of the KTU, e.g. a user. Accordingly, KTU may within embodiments of the invention be employed within authentication and verification activities. KTU may be user defined or machine defined. For example, KTU may include but not be limited to passwords, biometric data, an application programming interface key (API key), and an authentication token. A persistent KTU refers to a KTU intended to be changed, replaced or modified by the user. A temporary KTU refers to a KTU that has an expiry date and is provided to the user physically or electronically. Examples of temporary KTUs may include, but not be limited to, Government issued documents with validity dates, one-time passwords, an authentication code generated by a code generator associated with the user, a temporary access code etc.

“User Authentication” (UAuth) as used herein refers to, but is not limited, to the process of identifying a user by matching, comparing, or correlating a first set of data provided by or relating to a user with a second set of data stored upon the system and/or device. For example, UAuth may employ KTU of a user which is compared to BD which represents or can be used to correlate or determine if the provided KTU corresponds to an authorised user. According to embodiments of the invention user supplied data may be representative of the user's physical characteristics, representative of a user's sensory functions, biometric data, KTU, geolocation data, a user gesture, a user gesture with respect to a haptic interface. Within embodiments of the invention authentication may be permitted to fail a set number of times, after which, the concerned user is temporarily denied from executing the same ToF for a given period of time or until they have completed another UAuth process.

A “transaction” as used herein refers to, but is not limited, to an exchange of information or data to achieve communication, authentication, verification, a transaction, and in some cases to obtain another set of information or data. A transaction shall be considered to have a requesting party (TRP), an accepting party (TAP) and in some embodiments a managing party (TMP). For each transaction, or type of the later, a transaction process is inherently considered which is itself comprised of a single process or multiple processes. Characteristically, a transaction is considered to have a point of origin and one or more points of conclusion wherein, this origin and conclusion(s) are referred to as a segment of the transaction process as an overall transaction, e.g. purchasing at a POS within a retail environment, may have multiple segments of a transaction process, e.g. POS terminal to retail financial system, retailer system to financial instrument clearing house, and financial instrument clearing house to user's bank. Through these, it is usually considered that the TRP is alerted of the result of the transaction process and that other concerned parties may or may not be alerted. According to embodiments of the invention a transaction may require a GD to be provided for authentication, be between an RD and MD, be between an RD and a database, be between an RD and an AD, provide the result of an outcome of the transaction to the RD, provide a result to a non-requesting device, support embodiments of the invention, be performed with the TRP and TAP present on the same device or network, employ encrypted data, employ non-encrypted data, embody a transaction where the TRP is providing information relevant to the nature of the transaction itself and where the TRP only expects a confirmation response of the result of the transaction. Within embodiments of the invention a TAP may be comprised of one or more users and/or one or more devices.

A “Transaction Process” (TPr) as used herein refers to, but is not limited, to a sequence of network(s), device(s) and processes which the transaction will use to complete all of its tasks. A segment of a TPr as used herein refers to, but is not limited, to part of a process of a transaction, through which actions of the process can take place, information can be manipulated, or information can be in transit.

“Currency” as used herein refers to, but is not limited, to money in the real world, also referred to a Flat Currency, of which a given quantity represents a particular monetary value. Example, of flat currency include United States of America Dollars, European Euro, British Pounds, Japanese Yen etc.

A “CryptoCurrency” (CrCy) as used herein refers to, but is not limited, to a currency that only exists digitally, and which may be employed as a medium of exchange in cryptographic transactions, may form a means of authentication used to create additional units of the same cryptocurrency, or be used to validate the identity of its owner in a transaction or audit process.

“E-Currency” (eCy) as used herein refers to, but is not limited, to digital currency which can be used to perform a transaction wherein an E-Currency may include but not be limited to a currency and a cryptocurrency. E-Currency may be traded through digital mediums, pathways or systems, may be purchased, may be redeemed with currency or CrCy, employed to acquire currency or CrCy. An E-Currency may be acquired outside of the scope of a financial transaction but may also be used to purchase electronic or real-world tradeable goods or services.

A “Currency Exchange Mechanism” (CEM) as used herein refers to, but is not limited, to a transactional process through which one type of currency is exchanged for another distinct type of currency. An example would be to purchase Australian Dollars with Chinese Yens, or to purchase Bitcoins with British Pounds. A CEM may be offered by a Currency Exchange in some embodiments of the invention (CE). A CEM may be applied to a currency, a cryptocurrency, and an E-Currency.

A “Financial Transaction” (FT) as used herein refers to, but is not limited, to a process wherein a currency or something of value is exchanged/forfeited for other currency (e.g. in a CEM) or for goods and/or services (POS transaction at a retailer for example or online). A FT may employ an additional monetary beneficiary party (TMBP), which receives the monetary value being forfeited upon a successful transaction directly or as an intermediary. In some embodiments of the invention, an FT would be successful with a zero-value monetary amount being forfeited, allow a currency, CrCy or eCy to be forfeited by the TRP. An FT may exploit a CEM embedded within its TPr in order to allow the TRP and TMBP to transact in different types of currencies, may perform a transaction in which the TRP and TAP are exchanging their respective currencies, embody a transaction where the TMBP can be the TRP, TAP and/or TMP.

A “Payment Processor” as used herein refers to, but is not limited, to a system which handles the exchange of financial information between two or more users, in order to perform a FT. Typically, a payment processor will take the payment information of a paying party (payee), verify that the funds of the FT are available, and upon this being the case, forward the payee's payment information to the payment beneficiary's (PB) bank which houses it's bank account and savings. In some embodiments, the PB's bank may be a credit card company wherein the funds are transferred (credited) to the PB's credit account. In other embodiments instead of currency a CrCy or eCr may be employed solely or in part.

A “Financial Institution” as used herein refers to, but is not limited, to a financial registry, a financial provider, a bank, etc. whose main services are financial in nature.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. Accordingly, ML may refer to, but is not limited to artificial intelligence, filtering of data, threat detection related to malware, malicious intrusions, data breaches, etc., ranked learning analysis, computer vision, and character (text) recognition in both data and visual forms.

A “Graphic Marker” as used herein refers to, but is not limited, to a two-dimensional marking such as a drawing, inking, text, or graphic which can be interpreted by an algorithm or person. Examples, may include, but not be limited to, a bar code, a QR code, and a tattoo.

A “Merchant Location” or “Merchant's Area of Business” (MAB) as used herein refers to, but is not limited, to a geographic area within which a merchant operates its day-to-day business. A MAB may correspond to one retail location, multiple retail locations of a single retailer, multiple retail locations of multiple retailers, etc.

A “Transfer Medium” as used herein refers to, but is not limited, to any medium for example, wireless, physical, shared, through which data and information may be transmitted.

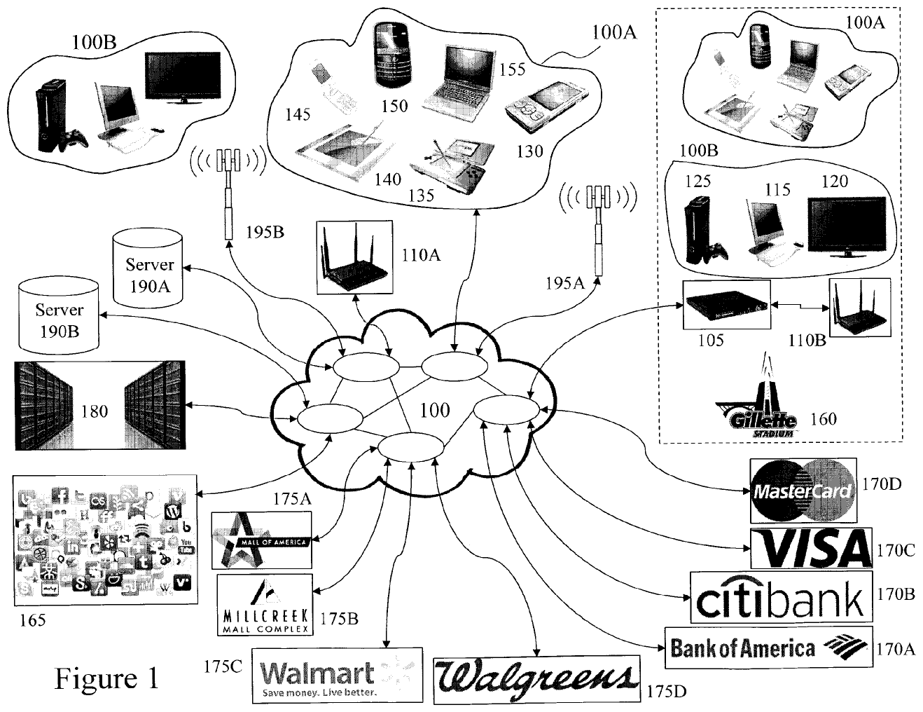

Referring to FIG. 1 there is depicted a network environment 100 within which embodiments of the invention may be employed supporting Financial Transaction Systems and Financial Transaction Applications/Platforms (FTS-FTAPs) according to embodiments of the invention. Such FTS-FTAPs, for example, supporting multiple communication channels, dynamic filtering, etc. As shown first and second user groups 100A and 100B respectively interface to a telecommunications network environment 100. Within the representative telecommunication architecture, a remote central exchange 180 communicates with the remainder of a telecommunication service providers network via the network environment 100 which may include for example long-haul OC-48/OC-192 backbone elements, an OC-48 wide area network (WAN), a Passive Optical Network, and a Wireless Link. The central exchange 180 is connected via the network environment 100 to local, regional, and international exchanges (not shown for clarity) and therein through network environment 100 to first and second cellular APs 195A and 195B respectively which provide Wi-Fi cells for first and second user groups 100A and 100B respectively. Also connected to the network environment 100 are first and second Wi-Fi nodes 110A and 110B, the latter of which being coupled to network environment 100 via router 105. Second Wi-Fi node 110B is associated with commercial service provider 160, e.g. Gillette Stadium™, comprising other first and second user groups 100A and 100B. Second user group 100B may also be connected to the network environment 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network environment 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network environment 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network environment 100 are Social Networks (SOCNETS) 165, first and second service providers 170A and 170B respectively, e.g. Bank of America™ and CitiGroup™, first and second third party service providers 170C and 170D respectively, e.g. Visa™ and MasterCard™. Also connected to the network environment 100 are first and second retailers 175A and 175B respectively, e.g. WalMart™ and Walgreens™ together with first and second retail malls, e.g. Mall of America™ and Millcreek Mall™, together with others, not shown for clarity. Accordingly, an MSME such as first service provider 170A engages with multiple users, e.g. seller and buyers of residential and/or commercial properties or renters/rentees of rental residential and/or commercial properties as well as other brokers, agents, etc. wherein these may include those within their own organization, e.g. first service provider 170A (OttawaDreamHouse™), another associated organization, e.g. second service provider 170B (RE-MAX™), or other service providers such as first and second service providers 170C and 170D respectively and first to fourth feed networks 175A to 175D respectively. In addition, information relating to properties, the first service provider 170A, or a specific realtor within first service provider 170A may be obtained from one or more social networks such as LinkedIn™ Facebook™, etc.

Also depicted are first and second servers 190A and 190B may host according to embodiments of the inventions multiple services associated with a provider of contact management systems and contact management applications/platforms (FTS-FTAPs); a provider of a SOCNET or Social Media (SOME) exploiting FTS-FTAP features; a provider of a SOCNET and/or SOME not exploiting FTS-FTAP features; a provider of services to PEDS and/or FEDS; a provider of one or more aspects of wired and/or wireless communications; an Enterprise 160 such as Multiple Listing Service (MLS) exploiting FTS-FTAP features; license databases; content databases; image databases; content libraries; customer databases; websites; and software applications for download to or access by FEDs and/or PEDs exploiting and/or hosting FTS-FTAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides FTS-FTAP features according to embodiments of the invention; execute an application already installed providing FTS-FTAP features; execute a web based application providing FTS-FTAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a CONCUS may, via exploiting network environment 100 communicate via telephone, fax, email, SMS, social media, etc.

Accordingly, FIG. 1 depicts a network environment 100 wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D. Optionally, rather than wired and/or wireless communication interfaces devices may exploit other communication interfaces such as optical communication interfaces and/or satellite communications interfaces.

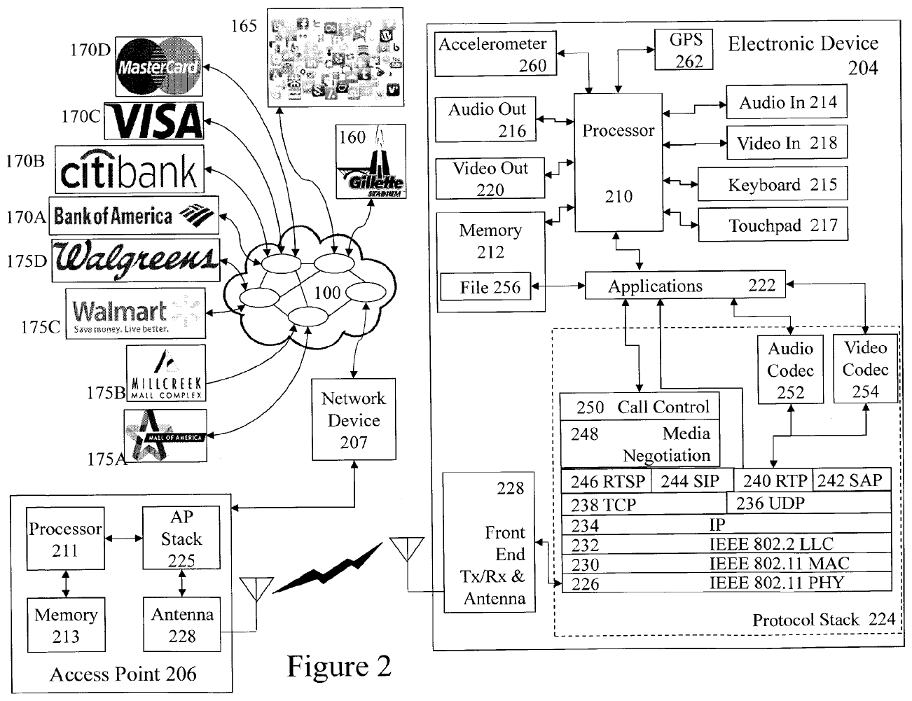

Now referring to FIG. 2 there is depicted an electronic device 204 and network access point 207 supporting FTS-FTAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network environment 100 and therein Social Networks (SOCNETS) 165, first and second service providers 170A and 170B respectively, e.g. Bank of America™ and CitiGroup™, first and second third party service providers 170C and 170D respectively, e.g. Visa™ and MasterCard™. Also connected to the network environment 100 are first and second retailers 175A and 175B respectively, e.g. WalMart™ and Walgreens™ together with first and second retail malls, e.g. Mall of America™ and Millcreek Mall™, together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like. Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the network environment 100 using the electronic device or within either the access point 206 or network device 207 wherein details of the transaction are then coupled to the network environment 100 and stored within remote servers.

Optionally, rather than wired and/or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

As noted supra amongst the concerns, particularly of the general public as users—subscribers—consumers, of contactless payment systems (e.g. NFC based contactless payment methods) and others exploiting location-based connectivity for transactions of any kind is that such transactions might unwillingly publicize a device owner's location information. Current methods for basic or social location-based services transmit the actual location of a device over a network connection and then have it re-transmitted to other relevant devices. Other peer-to-peer services also require a direct device-to-device recognition over a wireless medium (e.g. NFC), which can put both device owners at risk if such a direct connection is intercepted. Further, the transaction data is in itself sensitive and often targeted by cyber-criminals which makes the prioritization of location secrecy and security paramount.

Accordingly, the inventor has established methods and processes wherein the location information of both devices partaking within a transaction is globally correlated by the devices and the system that they are linked to in order to allow the transaction to take place in a safe and secure manner. Further, as the method exploits two separate communication channels to the system rather than a single communication channel between the two devices the interception of data relating to the transaction is now harder to achieve especially as the actual validation/verification information is now, within some embodiments of the invention, not provided to the PoS or mPoS terminal which merely receives a verification code from a separate independent server associated with the transaction or a server relating to the enterprise which receives the verification data for a completed transaction.

Embodiments of the invention remove the direct interchange of location data between the two devices by having each device separately grant permissions to a single centralized system or separate portions of a de-centralized system which secure and hide the identity of the location data from the other device(s) pertaining to the transaction. It would also be evident that within embodiments of the invention that a 2-device transaction may be an N-device transaction wherein authorization of the transaction requires not only the PoS device, the user's device but one or more other devices to authorize, e.g. a parent to authorize a transaction by a son or daughter or a manager to authorize an employee's purchase.

Embodiments of the invention transmit location information only to a remote server rather than any terminal such that the user s location is partitioned and isolated with only central verification which itself may be via encrypted location data. Further, within embodiments of the invention location data may be transmitted discretely in response to a transaction or alternatively streamed in a one-directional manner or transmitted in blocks rather than in response to the transaction or ongoing streaming thereby minimizing the number of network connections passing sensitive information.

Accordingly, embodiments of the invention provide a process and method of autonomously creating a premise between two computing devices that allows for a database transaction to occur between two parties and addresses the issues that stem from the concerns of security, data integrity, reliability and robustness without the need for a user to initiate such a process.

A: Coordinate & Requesting Device Identity Acquisition

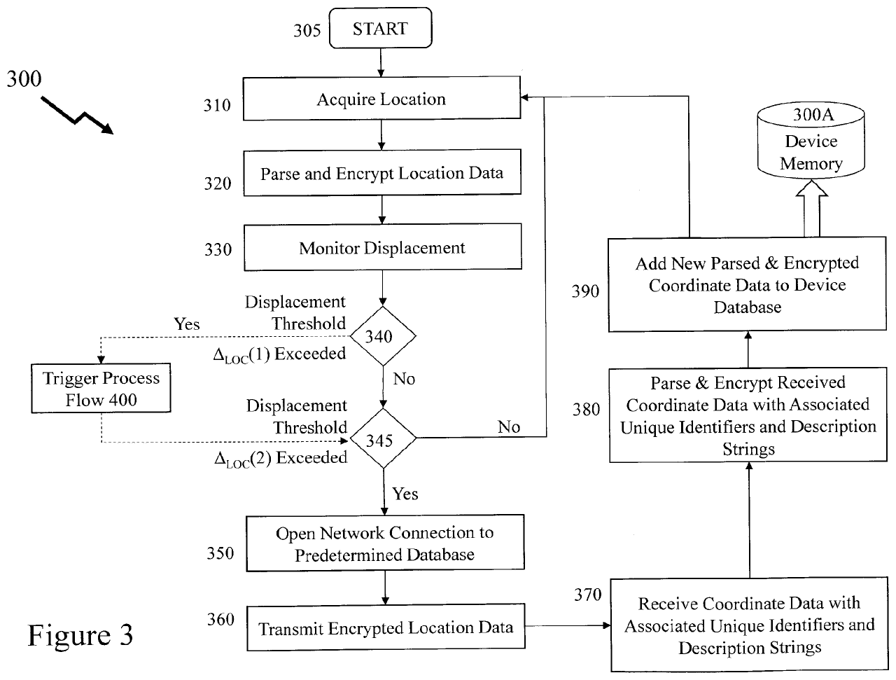

Now referring to FIG. 3 there is depicted an exemplary process flow 300 according to an embodiment of the invention relating to the acquisition of requesting device identity acquisition together with associated geolocation data.

Accordingly, the process begins at step 305 wherein the process is initialized, e.g. at first execution of an FTS-FTAP according to an embodiment of the invention upon a user's electronic device and proceeds to execute steps 310 to 345 within a decision loop. These steps comprising:
Step 310 wherein the device related to the user who will authorize their transaction, e.g. a purchase at a retailer (accordingly this device is known by the inventors as the authorization device or authorizing device herein) acquires geolocation data via one or more techniques as known in the art such as accessing a global positioning system (GPS), wireless base station triangulation, or wireless node association/identity for example (as will become evident the authorizing device may authorize a transaction of any kind);
Step 320 wherein the established geolocation is parsed, and encrypted with a key and stored locally within the authorizing device;
Step 330 wherein the authorizing device continues to monitor its location and determines a displacement from the last stored location;
Step 340 wherein the authorizing device determines whether the displacement exceeds a first threshold, Δ_{LOC}(1) and if has then the process 300 may trigger a separate process flow such as process flow 400; and
Step 345 wherein the authorizing device determines whether the displacement exceeds a second threshold, Δ_{LOC}(2) and if has then the process 300 proceeds to step 350 otherwise it loops back to step 310.

Once a determination has been made that the user has moved a predetermined distance away from a previously stored location in step 345 the process flow 300 executes an updating routine with a remote server supporting embodiments of the invention comprising steps 350 to 390. These steps comprising:
Step 350 wherein the authorization device establishes a network connection to the remote system databases that it is associated with through the FTS-FTAP according to an embodiment of the invention;
Step 360 wherein the user's device transmits via the network connection the encrypted location data of the device stored previously, e.g. in step 320;
Step 370 wherein the remote system in reply to the encrypted location data transmits to the user's device (the authorizing device) a series of coordinate data, e.g. geolocation coordinates defined by GPS coordinates or triangulation, each set of coordinates annotated with one or more unique identifiers and description strings;
Step 380 wherein the received series of coordinate data with annotations are then parsed and encrypted by the user's device; and
Step 390 wherein the parsed, encrypted coordinate data with annotations is merged to the device's stored database within its memory 300A and the process loops back to step 310 back into the local database of the device and are added to the list of already present coordinates, if any previous coordinates should exist on the device.

Optionally, steps 310 to 345 may be structured to always loop and upon the appropriate displacement conditions trigger process flow 400 and/or a second process flow comprising steps 350 to 390. Process flow 300 is described within the embodiments of the invention as being executed independently of the other process flows related to other aspects of the embodiment of the invention.

B: Transaction Platform Creation

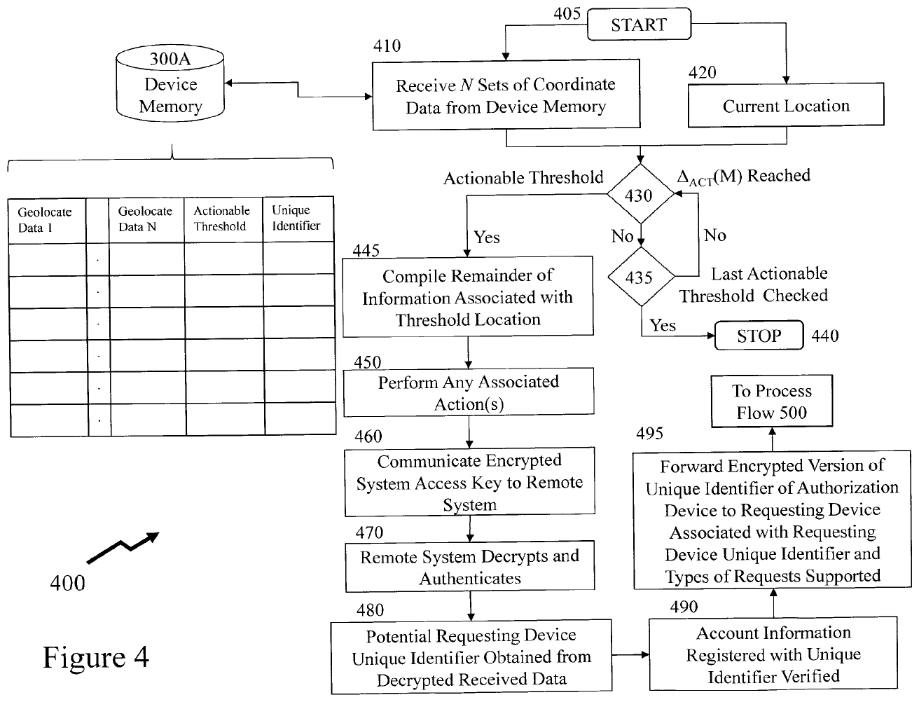

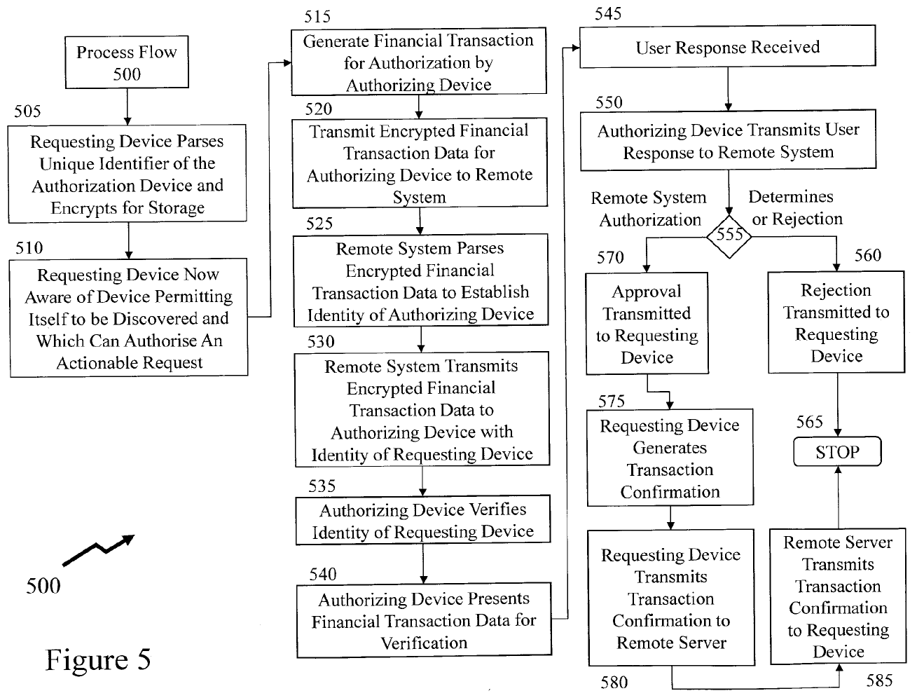

Now referring to FIG. 4 there is depicted an exemplary process flow 400 forming a first part of an overall process flow according to an embodiment of the invention in conjunction with process flow 500 in FIG. 5 relating to the creation and exploitation of a platform for performing a transaction.

Accordingly, the process begins at step 405 wherein the process is initialized, e.g. at first execution of an FTS-FTAP according to an embodiment of the invention upon a user's electronic device or based upon the trigger decision within process flow 300 in FIG. 3. The process begins at steps 410 to 435 which comprise:
Step 410 wherein updated coordinates received by the device from its remote server are retrieved;
Step 420 wherein its current location is established;
Steps 430 and 435 wherein each set of coordinates is compared to the location data of the device such that ultimately the process proceeds to step 440 and stops if no coordinate data set stored within memory matches the current location to a predetermined distance (or tolerance) or proceeds to step 445 wherein a coordinate data set stored within memory matches the current location to a predetermined distance (or tolerance).

Accordingly process flow 300 establishes a series of coordinates for the movement of the user separated by a predetermined threshold and for each new location the user's device transmits its location and retrieves from the remote storage sets of coordinate data with annotations. Accordingly, each set of coordinate data and its associate annotations relates to a PED, FED, or other item of equipment which performs a financial transaction in relation to a request for one or more goods, one or more services, or a combination therein triggered by an action of the user. Accordingly, a user walks along a street and every 250 feet their device opens the communications to the remote server, transmits its new current position, and receives a set of coordinates with annotation data. Each item is a PED, FED, or other item of equipment within 250 feet of the user's current location which can perform a financial transaction. Accordingly, the user's device now has a list of discoverable terminals with which a transaction can be performed.

The process of registering the geolocation data for each PED, FED, or other item of equipment supporting financial transactions may be established by one or more methods known within the art wherein, for example, upon registering a PoS terminal to a service its geolocation data is acquired and transmitted. This may be, for example, using geolocation acquired by the PoS terminal itself or as provided by another item of equipment. It would be evident within embodiments of the invention that a PoS terminal may execute a variant process to that depicted in FIG. 3 wherein the PoS terminal monitors its location and upon determining a movement beyond a predetermined threshold transmit now location data to a remote server database that updates the geolocation data associated with the entry for that terminal. Optionally, within an embodiment of the invention, as the user's device retrieves a set of coordinate data with annotations it deletes all existing entries so that it only maintains a list of PoS terminals relative to its current location and accordingly any adjustments in the locations of PoS terminals into/out of the location are reflected in its listing. Within other embodiments of the invention the user's device may maintain a history of PoS terminals with their coordinates and annotations or maintain only a current set plus any established by the user as a “favorite.” Hence, a user can “favorite” their local coffee shop, bank ATM etc.

As depicted in FIG. 4 the coordinate data saved on the device within the device memory 300A contain a parameter corresponding to an actionable threshold for each coordinate pair. Each pair also contains a unique identifier associated to a device located in the vicinity of the coordinates together with other data such as an actionable threshold. These other devices by virtue of being registered in the database as PoS terminals are therefore, once stored within the device memory 300A, PoS terminals that can request something from the authorization device comprising the device memory 300A.

As the authorization device monitors its own location data, it correlates it with the actionable thresholds and proceeds to execute a given function or method if such a threshold is crossed. For example, a PoS terminal may have an actionable threshold of 10 feet such that when the user's device now is within this threshold distance of the PoS terminal then the determination at step 430 is “Yes” and the process proceeds to step 445. Within an embodiment of the invention whilst the process flow 400 is depicted as terminating at step 440 if no actionable threshold is met the process flow may loop back automatically to step 405 and proceeds to retrieve now location data and coordinate data from the memory which may or may not have been updated by the separately running process 300 in FIG. 3.

Accordingly, now referring to steps 445 to 495 respectively based upon an actionable threshold being reached these comprise:
Step 440 the device compiles the remainder of the information associated with the threshold location;
Step 450 wherein the device performs any device-side function(s) which may include, for example, notifying the user they have entered a particular merchant's business, retrieving a preference of a user with respect to a merchant's business that they are now within or within proximity of, extracting information from a remote server for presentation to the user, etc.;
Step 460 wherein regardless of the associated action or existence of any associated action the device communicates with the remote system through a network connection and provides its system access key in encrypted form which validates the account and the device associated with the system access key to the remote system. This system access key also contains an encrypted key containing an identifier for the account associated with the device as well as an encrypted instruction also stored in the key and the unique identifier associated with the coordinate data for which the actionable threshold was met;
Step 470 wherein the remote system decrypts the encrypted system access key, encrypted key and encrypted instruction;
Step 480 wherein the remote system decrypts and extracts the unique identifier associated with the coordinate data for which the actionable threshold was met from the data received from the user's device of the authentication of the user's system access key etc. is successful;
Step 490 wherein the remote system processes the unique device identifier and checks the validity of the account information registered with the identifier; and
Step 495 wherein a successful and appropriate account status then prompts the remote system to forward an encrypted version of the unique identifier of the authorization device to the requesting device, along with information relevant to the types of requests that might be performed by the requesting device (e.g. the PoS terminal).

The types of requests may be configured by the user, the remote system, or account holder etc. Accordingly, a PoS terminal may be authorized by the remote system for a “debit” transaction only with maximum value $10 as the PoS terminal is associated with a fast food chain and the authorizing device is owned by a son or daughter of the account holder. Alternatively, a user may wish to acquire “travel miles” from their purchases and set their preference to “credit” as they acquire “miles” at higher rate on their credit card. Alternatively, the account information may be set to “retailer credit card” when the user is within an environment associated with the retailer so that they leverage “brand loyalty” points for example. Optionally, at this point the user's device may also trigger actions.

From step 495 the process proceeds to process flow 500 in FIG. 5.

At this point, within the exemplary process flow described and depicted in FIGS. 4 and 5, the basis of performing a transaction of any kind is established as this is where the requesting party or device (e.g. PoS terminal) is now aware of the presence of a user's device which is permitting itself to be discovered, and which can (eventually) authorize an actionable request sent by the requesting device. Accordingly, process flow 500 represents one such process flow for the establishment and authorization of a transaction.

Accordingly, as depicted the process comprises steps 505 to 585, wherein these steps comprise:
Step 505 wherein the requesting device parses the unique identifier of the authorization device and encrypts it for storage;
Step 510 wherein the requesting device is now aware of the user's device which is permitting itself to be discovered and which can authorise an actionable request;
Step 515 wherein the financial transaction is generated by the requesting device for authorization by the authorizing device;
Step 520 wherein the encrypted financial transaction data is encrypted and transmitted to the authorizing device via the remote system;
Step 525 wherein the user's device parses the encrypted financial transaction data to establish the identity of the authorizing device (at this point a transaction type that is not supported may be basis for terminating the process or moving directly to step 560 and stopping);
Step 530 wherein the remote system transmits encrypted financial transaction data to authorizing device with identity of requesting device;
Step 535 wherein the authorizing device verifies the identity of the requesting device against the unique identifier stored within the device memory 300A for the device meeting the threshold;
Step 540 wherein upon verification that the request comes from the correct requesting device the authorizing device presents financial transaction data for verification;
Step 545 wherein the requesting device logs the received user's response;
Step 550 wherein the authorizing device transmits the user's response to the remote system; and
Step 555 wherein the remote system determines whether the user authorized or rejected the request.

If the determination is a rejection then the process proceeds to step 560 and 565, these comprising:
Step 560 wherein the rejection is transmitted to the requesting device; and
Step 565 wherein the process terminates.

If the determination is an approval then the process proceeds to steps 570 to 585, these comprising
Step 570 wherein the user's approval is transmitted to the requesting device;
Step 575 wherein the requesting device generates a transaction confirmation;
Step 580 wherein the requesting device transmits the transaction confirmation to the remote server; and
Step 585 wherein the remote server transmits the transaction confirmation to requesting device.

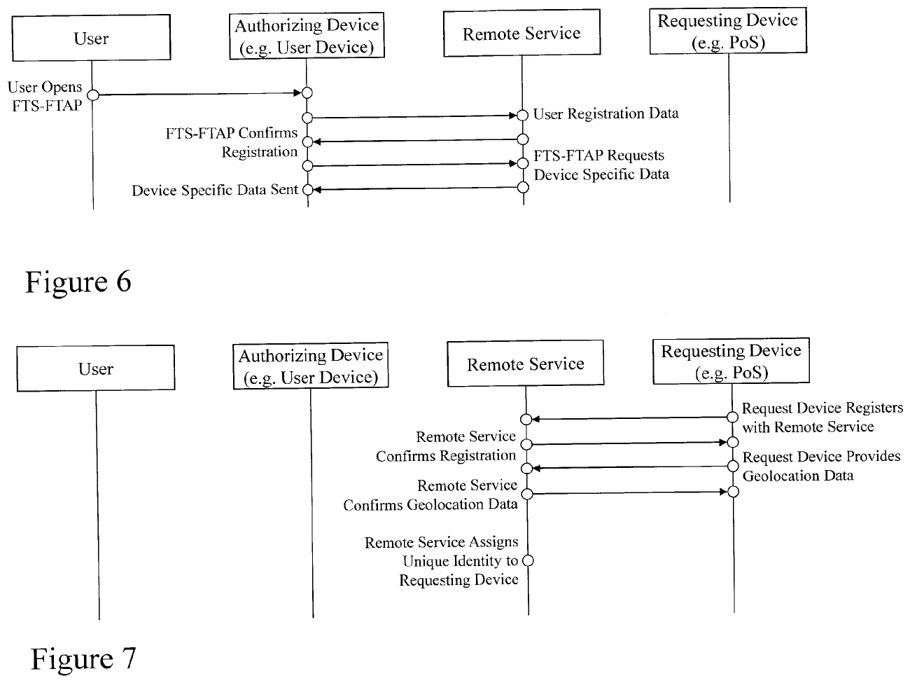

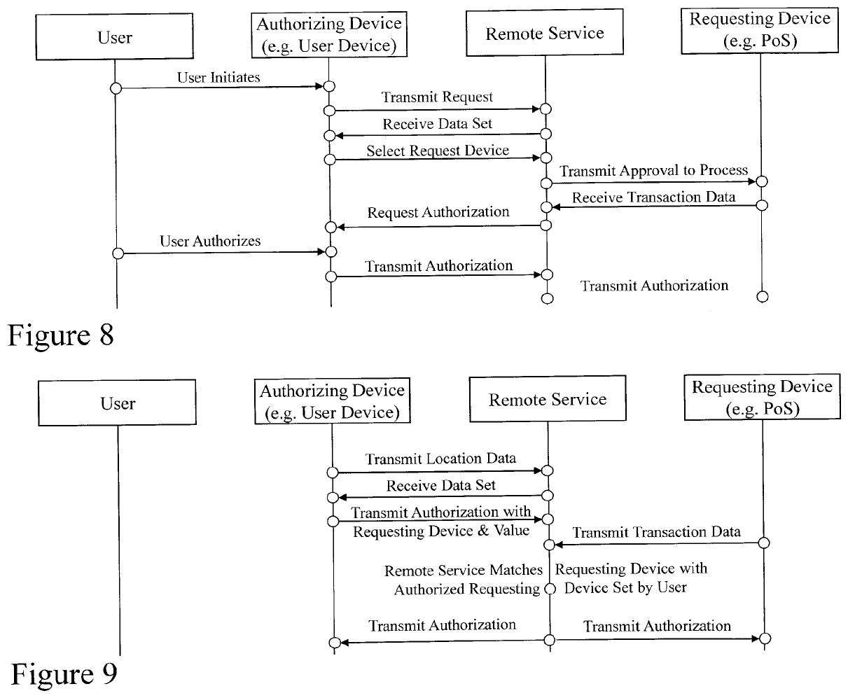

It would be evident to one skilled in the art that the process flow 500 represents just one potential process flow with respect to the establishment and authorization of a financial transaction which is completed based upon the association of the authorizing device to a geolocation which aligns with the geolocation of a requesting device and wherein authorization progresses without direct communications between the user's electronic device and the requesting device. Other process flows may include, but are not limited to, those depicted in FIGS. 6 to 9 respectively wherein these comprise:
FIG. 6 depicts an exemplary message flow relating to establishing a user's registration with a remote system according to an embodiment of the invention;
FIG. 7 depicts an exemplary message flow relating to establishing a requesting device's registration with a remote system according to an embodiment of the invention;
FIG. 8 depicts an exemplary message flow relating to establishing a transaction with a requesting device via a remote system based upon a user selecting the requesting device upon their authorizing device according to an embodiment of the invention; and
FIG. 9 depicts an exemplary message flow relating to establishing a transaction upon remote system based upon transaction and location data from requesting device and authorizing device.

It would be evident that the process flows according to embodiments of the invention allow for the requesting device to never actually possess knowledge of the authorizing device identity. For example, the remote system merely confirms that an authorization device is associated through geolocation and generates the transaction for processing where an associated action at step 450 to an actionable threshold being reached may be a “PAY” icon upon a user's smartphone being displayed for selection to initiate that the user wishes their device to be identified to the remote system. Accordingly, the remote system associates the requesting device identity/geolocation with the user's device/account information and provides the confirmation to the requesting device which never receives any data from the user's device.

Within embodiments of the invention a step within the process such as at step 510 for example wherein the requesting device is now aware of the user's device which is permitting itself to be discovered and which can authorize an actionable request that this may trigger a system, such as a gas dispensing pump at a gas station, to enable. If the actionable action was in this instance approval to authorize a transaction to a maximum predetermined value, e.g. $50, that the gas dispensing pump can proceed to dispense for user without the user actually having to perform any action upon their electronic device which may be beneficial in full service gas stations, allowing a user to fuel without fumbling for smartphone and pushing buttons when windy and −30 C etc.

In other embodiments of the invention multiple PoS terminals may be made aware of the device wherein scanning of a user identification code transmitted with the request for authorization from a specific terminal identifies the specific PoS Accordingly, the user does not need to be enrolled with every retailer to be given a unique identifier of their retailer account or use multiple retailer applications. Their own personal code generated by the remote system either at registration or upon determination of an actionable event, therefore collapses the multiple PoS to a single selected poss. For example, within many fast food retailers, coffee shops, supermarkets etc. multiple PoS terminals may be within a 30 cm-2 m (12″-72″) of each other and hence at distances below the resolution of a geolocation system providing data to the remote system regarding the user's geolocation or that used to establish the geolocation of the devices. This may also allow a PoS to be associated with a region such as establishing a single mPoS for a transaction with the user within a restaurant employing multiple mPoS devices.

Optionally, the system also supports automated payments for services etc. as the PoS associated with a location may be a “virtual PoS” or a kiosk/terminal supporting cash/card payments but not equipped for wireless transactions such as a parking meter. Now a physical parking meter may be associated with a geolocation for which the user can pay for parking when within a specific distance provided the geolocation is registered with the remote system and the requesting system is virtually associated with the physical element in that it is a software application in execution upon a remote server.

Optionally, within other embodiments of the invention the process may selectively enable wireless near field communications in that the authorizing device will only respond when a request for NFC communications is received from a device having an identity matching one stored within its device memory 300A as the set of coordinates with unique identifier etc. Optionally, the user can thereby establish a specific PoS terminals as “allowed” which are automatically enabled when the user's location meets the actionable threshold for that PoS terminal. Accordingly, it would be evident that embodiments of the invention that establish a geolocation-based process for a user's device to be “discoverable” with respect to a geolocation specific PoS terminal, unique identifier etc. that are compatible with financial processes known within the prior art but provide enhanced security in that wireless interactions and/or transactions cannot be fraudulently made, or security information intercepted.

Whilst embodiments of the invention have been primarily described and depicted with respect to the provisioning of an authorization by the user with respect to the execution of a financial transaction it would be evident that within other embodiments of the invention the process may exploit similar process flows and sequences of message flows/decisions etc. but that rather than authorizing release of a financial funds to complete a transaction that the approval/authorization may relate to another service or function either directly related to the user, indirectly related to the user, or controlled by the user. For example, the authorization may relate to the provisioning of electronic content, e.g. medical records, enterprise documents, music, multimedia content etc.

Accordingly, embodiments of the invention may relate to processes or functions of a financial nature such as processing payments, managing payment requests, managing bill payments, managing scheduled bill payments, managing legacy currency transfers between consumer (Peer-to-Peer) or corporate banking accounts, managing virtual currency transfers, that enables using virtual currency as a payment method, the use of loyalty programs (both native to the system or of third-party nature), generating a process which brokers the use of loyalty program currencies as an payment method option in a transaction, that holds currencies for a registered legal person in the form of an account (for banking, trading, holding, retirement, investment or any such purpose-oriented product as might be offered by a banking institution) or a wallet (mobile wallets or any equivalent money holding structure).

Accordingly, embodiments of the invention may relate to processes or functions of a system relating to electronic content such as the registration of a user, the exchange of a user's personal information, financial records, the validation of credentials, granting access to electronic content, permitting access to restricted electronic content, transmitting or receiving a user biometric data and/vital signs to and/or from a computing or non-computing device, the localization of a user-registered device worn by a user, the localization of a user-registered device which is implanted or surgically grafted to a user, the localization of a user-registered device that qualifies as an implant which may or may not be a computing device, the localization of a registered device that is associated with a sentient user that is of relevant importance to said system.

Accordingly, embodiments of the invention may relate to processes or functions of a dealing with an individual's (referred to as the individual) personal information or personal electronic content such as the ability for the individual to send their personal information to another device associated with themselves or another user, the ability to allow automatic and requested collection of personal information by designated and registered devices of such a system, the ability to share personal information with a nearby device in order to acquire goods offered by or a service provided by another individual, the ability to detect nearby services from individuals and automated devices, the ability to allow secondary individuals to submit their personal information on a device registered with the system in order to allow the secondary user to perform actions relevant to the system.

Within embodiments of the invention described supra the authentication process is based upon a geolocation process exploiting one or more methodologies such as GPS, wireless triangulation etc. However, it would be evident that there may be instances wherein these are unavailable or an additional verification/authentication step is required. Accordingly, embodiments of the invention may exploit activation and acquisition of a digital image or digital video from a camera forming part of a PED, FED, wearable device employed by a user. Accordingly, the user may be requested to establish their location with location data provided to the remote system which is correlated with location data on the remote system in order to validate the user's location. Optionally, the same methodology may be exploited to establish the location of a requesting device allowing for highly mobile mPoS methodologies or temporary PoS instances such as at a market etc. Within some embodiment of the invention the currently acquired content is correlated by capturing still images, or video, for the analysis.

Accordingly, the requesting device and/or the authorizing device may prompt the user to enter a textual description of their location, e.g. Corner of 3^{rd} Avenue and Bank Street, and provide an image or images of their location. The remote system may then process the textual description of the location to identify location features etc. such as through Google™ Street View for example to retrieve location specific image content for correlating to the content provided by the user. Additional verifications can be provided such that stored content is not employed again as the upload may be compared to others previously uploaded for matches or weather conditions can be extracted and compared with a third-party service such as a weather network. In addition to analyzing the image content for geographical features the image may be analysed for contextual content.

Accordingly, location dependent image content can be employed as part of the information correlated in order for one or both devices to perform the functions associated with embodiments of the invention and/or one or more other aspects of services, features, items, locations, venues or points etc. Such information may be correlated and/or analysed based upon a user's pre-defined or independently acquired set of preferences. Optionally, the camera may be employed to detect and/or associate an individual, group of individuals, machines, devices, patterns, or other items which might be important for a pending, impending or anticipated data transaction. The acquired content may be analyzed against content established from a previous transaction with a remote database or another device.

Accordingly, it would be evident that a requesting device may establish its location with a remote system according to an embodiment of the invention through acquired image content rather than providing GPS or other geolocation data. Further, the user's device as an authorizing device may similarly provide its location through the provisioning of acquired image content rather than through GPS or other geolocation data thereby triggering the download of local requesting devices and their unique identities.

Within an embodiment of the invention a requesting device and/or authorizing device may establish their associations with respect to each other and/or a geolocation through acquiring image content of a geometrical and/or contextual shapes established by the remote server or another server wherein each device displays unique varying content such that the remote server can established based upon the acquired image content the device the content was displayed upon and when it was displayed. Accordingly, a user can image the displayed content upon a PoS and upload it to the remote server which then associates that the device providing the acquired image content is the authorizing device and the device it was displayed upon will be the requesting device. As such the association is made without geolocation data or in addition to geolocation data. Accordingly, the geolocation data is validated or verified with the acquired content as this can be device and time/date specific.

Within other embodiments of the invention the data transaction may be performed through exploiting voice-activated commands or through tactile actions initiated by a voice-recognition algorithm or by a second device. Optionally, the authorizing device instead of establishing user authorization through tactile commands or voice commands may exploit other biometric authorizations such as facial recognition, fingerprint, retinal recognition etc.

According to an embodiment of the invention either a user and/or a device associated with a user may act as at least one of a TRP, TMP, TAP, and a TMBP in order to provide required FI to a FT wherein the user and/or device may execute a dedicated function associated with the device in order to provide the FI to the FT. Where the user executes the dedicated function they may do so, for example, through an application in execution upon the device, through a web site accessed through a browser in execution upon the device or through a graphical user interface, web site, or viewing area to perform or order itself or it's device to execute given commands store in device memory relevant to the later claims and embodiments. Where the device executes the dedicated function then it may do so by executing stored commands within its memory to perform the relevant steps. Accordingly, a device may automatically execute a process for the transfer of FI to a FT as the result of the user entering a defined geolocation that has been associated with a user's previous FIs by the user or through one or more ML processes, e.g. they walk into the same coffee shop every weekday and buy a coffee. Examples of devices may include, but not be limited to, a PED, a FED, a MD, an ARD, a VRD, a vehicle, a FED, and a POS.

A user may in providing the required financial information manually created the request for a given FT. Alternatively, a device in automatically providing the required financial information (FI) may delegate the generation of it's financial information to underlying software which could, for example, fetch the FI from a SecE1 or fetch the FI from a RD. Optionally, the transmitted information is encrypted when transmitted, be in plain text, or be in the form of a tokenized representation of the financial information. Alternatively, the device may provide instructions to a FI processing network which houses the TRP and TMBP's FI to process the transaction by providing this network with user credentials to properly identify the parties involved.

Accordingly, this user (henceforth referred to a the requestee) may through another individual, a representative of the user, or a device authorised to act on behalf of the user perform different tasks including:
Request from another user of the system (henceforth referred to as the requested) to pay for a good or service;
Request that another device associated with the requested pay for a good or service;
Request to obtain a good or service from the requestee;
Request data from the requested via a transaction process;
Request data from both the requestee and requested via a transaction process.

For example, the requestee embodies a merchant, a user, a customer, a third-party, a service provider, a financial institution etc. a merchant and the requested embodies a merchant, a user, a customer, a third-party, a service provider, a financial institution etc. Actions by either the requestee or the requested may or may not require human interaction, commands, authorization, authentication etc. in order to fulfill the functions and features of embodiments of the invention. Where a requestee or requested is a merchant then this may refer to a single merchant location or a collection of locations owned by a merchant. A merchant may in some embodiments be consisted of locations whose devices operate within location-specific LANs or one or more networks such as a dedicated network, the Internet, or a network which executes functions on behalf of a merchant.

A requestee, e.g. a merchant, may in some embodiments dedicate or delegate some features and functions to a CoPU which may form part of a peripheral device, an additional device, an additional merchant network device, a remote network, a server either on a remote network or within a LAN, a device with dedicated TPr, and a ML. A requestee or requested, e.g. a merchant, may in some embodiments apply embodiments of the invention to permit transactional functions to be executable from devices which have undertaken an authentication process such as LAuth, UAuth, or that contain pre-installed or installed identifiable credentials which are used to validate their network-dependent and medium-based transactions.

A requestee, e.g. a merchant, may exploit embodiments of the invention whilst being connected to an overseeing service-specific network which provides higher-order methods of analysis and, or control of the interfaced networks with merchant-specific metrics which would allow the later to monitor their MAB as is described in claim 4.f. This network could perform its tasks whilst:
being involved in the various TPr's that constitute the merchant's network of devices over all of it's locations and within the TPr of used features of the invention; or
communicating directly with some, or all of the devices that constitutes the merchant's network.

A requestee, e.g. a merchant, may in some embodiments, desire to perform a FT by allowing or designating a FT authorization process to be available to a customer when the customer wishes to leave the area of business or the requestee desires to settle an invoice or bill payment for example. Accordingly, the customer may be present or not present within a merchant's area of business. Further, in dependence upon the type of request the merchant may:
(1) empower the requested's device (or in commercial cases, the customer's device) to be the TAP in the TPr;
(2) define one of its devices to be the TAP when the requested's device or customer's device has poor connectivity to it's network;
(3) define one of its devices to be the TAP when the requested's device's user cannot or will not assume the role of the TAP; and
(4) require that either a combination of (1), (2) and (3) be applied together or independently in order to produce a positive TPr result.

Within embodiments of the invention a requested (e.g. a customer) may perform a secondary UAuth which is prompted on their device from a command issued by a requestee (e.g. a merchant device) in order to complete the TPr wherein:
the requested device is presented with a partially completed, or fully completed, TPr form in order to complete the UAuth; and
the requested (e.g. customer) is presented with the transaction form which requires it to specify selections and options which will determine the TPr of the transaction, from which the process proceeds thereafter.

A merchant may in some embodiments, provide a means of allowing the customers to identify its area of business by either:
providing devices and mechanisms to facilitate LAuth methods which would allow for LAuth to be performed by customer devices;
providing a listing of it's location(s) by one or more LSD, RSD, and NSD; wherein
the means may be implemented by a merchant device.

A merchant may, within embodiments of the invention, may exploit non-device elements or devices within its locations to provide a greater degree of location accuracy or aid in maximizing the authentication and identification factors relating to their area of business. Such non-device elements or devices may be employed to update the customer device with information concerning its immediate proximity of the device within the merchant's location such as, for example, landmarks, points of interest nearby, points of interest around the location, images, and tagged geolocation data. Such non-device elements may include placing graphics markers or patterns within the location(s) which when scanned, record, captured such as via a camera within the customers device provide this additional information. Devices providing improved location accuracy may include beacons or short-range transmitters which repeatedly broadcast or are paired to the customer's device. Optionally, such non-device elements or devices may also provide directly or in association with other graphic markers and/or devices other LAuth and Identification methods.

Optionally, a merchant may exploit cameras or other devices to capture location data of customers or to trigger additional information being presented to the user or to identify customers from merchant staff etc. For example, a merchant may perform UAuth on users and location employees in order to distinguish them properly by using UAuth and BI comparison methods. Such techniques may exploit ML methodologies as well as secure cloud-based storage elements such as blockchain, for example.

Accordingly, within an embodiment of the invention a financial transaction may be authorised by receiving first data relating to a requestee seeking to establish the authorization, receiving second data relating to a requested seeking to authorize the financial transaction, processing the first data and second data with at least one machine learning process or a plurality of machine learning processes to establish whether an authorization may be issued, and storing the result of the determination within a blockchain.

Accordingly, a merchant may communicate with an authenticated user, or to the device of a user, in order to:
update the user or user's device in respect of its location information;
prompt the user of available features, products, services, methods etc. with respect to the location;
trigger a notifying alert on the user's device interface;
interact with the user with a financial services device (FSD) comprising an audio-visual terminal in the proximity of the user;
sending a notifying alert to the user's contact information associated with it's UAuth BD;
execute tasks or functions according to embodiments of the invention relating to financial transactions.

A merchant may, incorporate within embodiments of the invention, visual UAuth and LAuth processes within a dedicated FSD which can:
incorporate a viewing area which is also a user interface for customers to perform transactions, FT's and other merchant specific tasks with the merchant's network;
perform the tasks of a POS;
automatically process user input by correlating said visually captured input with the customer's interaction with the FSD.
enable the merchant to take advantage of the process which is embodied in claim 10.c where the concerned merchant device is an FSD.

Within an embodiment of the invention the FSD is a merchant device. Optionally, in some embodiments where audio-visual capture is performed, the visual capturing portion of the FSD is integrated into the device or it can in certain versions of the invention be an MFD, a set of MFD's which are either incorporated within, around or around and within the device. According, to embodiments of the invention the MFD may be an integrated unit of the device or the MFD may be accessible to the device via one or more networks and/or media. Optionally, the FSD may be a PED capable of performing the tasks for capturing and processing visual input. A merchant's device may within embodiments of the invention perform UAuth by reading two-dimensional and/or three-dimensional machine readable and/or mathematically interpretable graphics produced on a visual interface or displayed on the exterior of the customer device. Such an embodiment would allow a set of customer and merchant permissions to be granted in advance to provide for automated and self-monitored FTs to take place.

A merchant's device(s) may exploit visual UAuth for example if the customer interfaces with a vehicle. Optionally, UAuth may also be performed in respect of the vehicle, the vehicle's driver, controller or automated pilot etc. Optionally, said UAuth may be by means of visually detecting and authenticating a public KTU displayed on the vehicle which may include, its license plate, a serial number distinctively visible from the outside of the vehicle, a regulatory approval/license displayed within the vehicle or upon the vehicle. Optionally, both the customer and merchant may be vehicles within embodiments of the invention or the merchant may be an automated toll booth, a parking machine, a periodic automated toll system upon a highway, a toll associated with an item of infrastructure for the vehicle(s) etc.

Accordingly, a vehicle may include a video-capturing device or image capturing device allowing a FT to be defined based upon the duration of the customer's use of the vehicle or optionally, the vehicle may charge the FT in dependence upon an indication of distance or a combination of distance and time. Optionally, the image/video may be used discretely or in combination with other processes perform UAuth of a user with respect to the vehicle (e.g. a taxi being a specific example of a merchant location and one that is vehicular) per claims pursued in claim 17, the merchant may use a version of the invention where the processes of claims 17 are combined to the following in order to increase the volume of UAuth processes used to verify the identity of a customer within a merchant's location. Within embodiments of the invention a vehicle may initiate processes relating to a FT or it may perform LAuth by correlating information within a LGD with systems installed within or upon the vehicle as can be used in methods of the description of LAuth. Optionally, data from other image sources such as traffic cameras may be processed to provide location data of a vehicle based upon image recognition/feature extraction of unique visual identifiers upon the vehicle.

Optionally, a vehicle's driver/controller/pilot or command unit are allowed by the merchant's network to process a customer's FT directly rather than via a central financial system of the merchant. Optionally, a set of customer and merchant permissions may be granted in advance to provide for automated and self-monitored FT's to take place. Optionally, embodiments of the invention would further allow the customer and merchant to forgo and delegate usual physical payment authentication (such as Known-Your-Customer documentation and Personal Identification Numbers), settlement and Know-Your-Customer verification to the merchant's network processes according to embodiments of the invention.

Accordingly, embodiments of the invention provide for a user to be prompted to interact, approve, confirm or participate in at least one of a transaction, a FT, a merchant-requested UAuth, a merchant-requested LAuth, or other processes as defined or required in accordance with embodiments of the invention.

Within embodiments of the invention the user may be prompted to interact with a form which has been generated or become accessible due to a command or task executed from or by a merchant, customer or user device. The form may be issued to the merchant's network for handling, issued directly to the user through a transfer medium, or fetched from an LSD, RSD or NSD by having initiated a user-device function triggered. Optionally, the user may be a device acting independently from its associated user or the user and customer are each an autonomous and human-independent device acting upon, for example, pre-programmed tasks, anticipated tasks, or providing a service for a third user. A form may be any visual presentation providing information to a user and exploit designs, content, layouts, etc. as known in the prior art and as favoured by each merchant. Optionally, a user response must contain parts of the merchant-network request as a means of validating the source of and/or identities involved with the request. Optionally, within embodiments of the invention UAuth and LAuth processes relating to a FT are user-requested and/or must succeed in order to permit a transaction to take place. Optionally, within other embodiments of the invention LAuth may not be required either to be performed and/or succeed in order to permit a transaction to take place. Accordingly, LGD may be acquired and combined within an FT as part of the financial transaction record without requiring that the location match that of the user.

Optionally, within other embodiments of the invention the described processes and methods relating to a financial transaction may be performed with respect to allowing access to other information such as electronic content, data, information etc. for example upon the merchant's system/device etc. or the customer's/requested's device. Said electronic content, data or information may be in a computer-interpretable only format and/or in a human-interpretable format.

Within embodiments of the invention a merchant's device, merchant's network, customer device etc. may undertake regular connections with other service providers or maintain continuous connections with other service providers. Within embodiments of the invention electronic content, data, information, UAuth, LAuth, FTs etc., may exploit one or more databases. Optionally, said database may be stored upon a dedicated subnetwork, server, or device which may in some embodiments act independently of any other associated devices, networks etc. it's super-network counterparts. Within embodiments of the invention the database forms part of the TPr.

According to embodiments of the invention information transmitted between devices may be in a single message/packet of data or it may be fragmented over multiple messages/packets of data. Where multiple messages/packets of data are employed then these may be stored within different locations, in the same location but different memory or storage devices. Where multiple messages/packets of data are employed each message or packet of data may include an identifier such that the original information may be reconstructed from the multiple messages/packets of data due to these identifiers. The identifiers associated a message may within embodiments of the invention be stored in a centralized system, stored themselves within a fragmented way, within the same location as the fragments to which they relate, within a different location to the fragments to which they locate or solely within each fragment to link fragments such that a remote system only accesses or retrieves the location of the first fragment. Fragments and/or identifiers may be stored in encrypted according to a single encryption key, encrypted according to multiple encryption keys, encrypted with different encryption keys or sets of encryption keys for the fragments and identifiers or unencrypted. Similarly, non-fragmented and fragmented information may be stored encrypted or unencrypted.

Within embodiments of the invention data or information whether fragmented or non-fragmented may be stored within a ledger-based file-system or records (referred to a ledger for simplicity) wherein:
recorded entries are representative of the nature of the transaction being performed;
entries are only recorded if the TPr performing the entry provides an authentication credential;
the ledger may be unique, discrete, distributed, copied and/or duplicated over to other file-systems or networks (henceforth referred to as distributions);
the ledger and any associated connected distributions of the ledger are updated simultaneously, continuously or periodically;
the ledger may only accept an entry submitted by a TPr through a mathematical process of evaluation; and
the connected distributions may only perform an entry if all connected distributions' file-systems accept the entry being submitted by a TPr through a mathematical process of evaluation.

Optionally, the ledger file-system may exploit one or more blockchains as known in the art.

Information for the ledger and/or the connected distributions may be encrypted while in transit in the TPr, not encrypted while in transit in the TPr, encrypted upon being saved within a database, cache or ledger, encrypted and decrypted during transmission through the network or is transmitted with a separate message indicating to which transaction the data relates. Encryption may exploit encryption keys stored upon one or more of the network to which the devices of the requestee and requested are connected, the requestee's device, the requested's device, and both the requestee and requested devices. Optionally, the TPr may require that information received was encrypted from it's network or device of origin or that it was subsequently encrypted by an encrypting party which is, for example, a requestee device, a requested device, an element of a third-party, or an element of a network to which the requestee device and/or requested device are connected. Optionally, a device of origin manages the encryption key, for example, within a LSD, RSD or NSD and is only accessible to it. Optionally, the encryption key is also accessible to other specific devices or network elements. Optionally, the device of origin of the information is the device performing the encryption or the device of destination of the information is the device performing the encryption. Optionally, the information is cryptographically signed by each segment of the TPr. Optionally, information is saved to memory, cache and, or ledger, and which is cryptographically signed by the device saving it. Optionally, a ledger file-system could in some or all embodiments of the invention be implemented using blockchain.

Embodiments of the invention may require that all or parts of a TPr described by the embodiments of the invention require some form of authentication which is supplied by the initiating device of the TPr, supplied by the authorizing device of the TPr, or supplied by one or more other devices which comprise the remainder of the devices involved in the TPr. Optionally, a segment within a TPr may explicitly refer to the requirement that authentication be performed by at least one of LAuth and UAuth. Optionally, each device described requires a form of authentication to be provided along with the information packet of the TPr in order to fulfill its role within the TPr, each segment of a network involved in the TPr requires a form of authentication, or each network involved in the TPr requires a form of authentication. In embodiments of the invention where an authentication credential is required for the TPr to proceed successfully, a device, segment or network may:
require a credential which has or can authorize the processes of the devices, segments or networks which preceded it within the TPr;
require a credential which has or can authorize the processes of the devices, segments or networks which succeed it within the TPr;
require authentication in the form of LAuth;
require authentication in the form of UAuth; and
require authentication to succeed otherwise said device, segment or network may prevent the TPr from beginning or proceeding.

Whereas all TPr described within this specification pertain to packets of information, a version of a TPr may also be applied to a tokenized packet of information, to a form of transaction of information; a part of, the majority or entirety of the TPr may be compliant with an industry accepted protocol, industry accepted standard, national standard or international standard. Optionally, some or all segments of a TPr may be the subject to monitoring by a tracking and or chronological log system.

Optionally, a server may fulfill the role of a party of a transaction, be a dedicated device, be a merchant's dedicated device in a FT, be a merchant's dedicated device in performing transactions, be an interface representing a merchant's goods and services in transactions or receive dedicated or regular commands from a PPI.

Optionally, a segment within a given TPr may be a payment processor, may be compliant with an industry accepted protocol, industry accepted standard, national standard or international standard but does not process a FT. A segment may comprise multiple payment processors. Optionally, processes handled within a payment processor are a distinct form of a transaction whose result inherently determines, for example, the success or failure of the encompassing TPr or which possible subsequent segments of the TPr that can be undertaken. A payment processor may apply to a financial institution, a service provider essential, or non-essential to the nature of the transaction in question, an authentication service and/or identity provider, a service which is hosted by a cloud provider, a government organization, a non-profit organization, an open-source service or tool, a shipping and or logistical service, or a dispatching service for some, all or any combination of the aspects of a TPr according to embodiments of the invention.

Optionally, one or more portions of a TPr may employ a blockchain-like distributed consensus system (DCS) which may within embodiments of the invention prevent a modification of prior entries once they have successfully been evaluated by the DCS wherein a failed entry may result in the failure of the TPr or it may not result in the failure of the TPr but act to instruct the managing segments of the TPr to consider other processes. Optionally, such as DCS may also be employed to perform or execute LAuth, to perform or execute UAuth, or be used in combination with other aspects of the invention with respect to permission, authentication and accessibility. A DCS may be an individual DCS or it may comprise processes that collectively provide a DCS. A single DCS or multiple DCS may be employed.

Where an embodiment of the invention, relating to it's various processes described, where a customer and merchant were specified, two distinct entities which respectively qualify as users, wherein neither of them constitute a commercial, corporate, non-profit or government entity (or merchant), the term Peer-to-Peer Transaction (P2PT) may be considered instead of a transaction or FT. Wherein a transaction described according to embodiments of the invention may be referred to as a P2PTPr. Other terminology from the definition of a P2PT also applies. In which case, a P2PT shall refer to it's requesting and requested users as peers. Accordingly, a P2PT may constitute a FT or it may constitute a transaction. Optionally, a peer may be a user, a device which is acting on behalf of another peer, may be acting upon the behalf of a third peer, may be acting on behalf of a group of peers, or it may be a merchant or merchants. Optionally, a peer may be the requesting party of the transaction or the requested party of a transaction.

Within embodiments of the invention a segment of a TPr, segments of a TPr or the entire TPr may employ devices and/or systems exploiting software that includes one or more ML processes. Such a TPr may include a P2PTPr. Such ML process or processes may be employed for example to determine which subsequent segments may, may not or will constitute the remainder of the TPr. Such ML process(es) may be managed by an entity, program or device.

In an embodiment of the invention, a transaction being handled by one or more ML processes discretely or in combination with one or more non-ML processes may render a service for example, but not limited to, on behalf of the requesting party, on behalf of the requested party, or on behalf of both parties of the transaction. Accordingly, a segment of a TPr may include ML programs, outsourced ML programs, or be a ML program. Optionally, all, some or the majority of devices within embodiments of the invention may contain ML programs, outsource ML programs, or exclusively host one or more ML programs.

Within embodiments of the invention machine-learning programs may be supervised, partially supervised, unsupervised, autonomous or combinations thereof. Within embodiments of the invention a machine-learning program may be employed in an analytic role, a managing role, an execution role, another role or a combination of roles.

Optionally, a transaction may be exclusive to and only accessible by the party or parties for which the service is being performed or a TPr may be performed on the condition that a financial cost is being incurred for example, but not limited to, by the requestee, by the requested, by a third-party, or by several third-parties. A process associated with such a financial cost for a TPr may be collected and distributed as part of the TPr for the FT, by a distinct FT from the concerned TPr, by a second FT distinct from a first FT associated with the TPr. Optionally, an embodiment of the invention could add the incurred cost to the sum of the monetary value of the FT before or after taxation rates are applied if the FT in question must impose taxation rates.

Optionally, a third-party to both parties may collect the cost as per a pre-arranged amount of access to the service being provided. A third-party to both parties may collect the cost on the basis that it is the owner of the segments managing the service. Optionally, the collector of the cost may allocate portions of the cost of the TPr based upon an agreement between the providers of the discrete segments of the TPr, an agreement associated with the requestee, an agreement associated with the requested, or another agreement between one or more parties associated with one or more segments of the TPr.

Incurred costs may be separate from the primary TPr and may be in the form of:
a single payment;
recurring payments;
fixed-amount recurring payments;
variable-amount recurring payments; and
recurring payments having fixed and dynamic variables that determine its amount.

Within embodiments of the invention all, a portion of, or the majority of the components involved in the TPr or P2PTPr may be:
owned or managed outright or in majority by one of the parties of the transaction;
owned or managed outright or in majority in co-ownership by all parties of the transaction;
owned or managed by a third-party to the transaction's parties;
manufactured by the same supplier;
manufactured by more than one supplier;
may not owned by the service provider but are owned by the parties, and the other device owners;
owned by the service provider;
managed in respect of development, maintenance and deployment by a third-party service provider; and
have access to them controlled.

Within embodiments of the invention a given service provider described therein may suspend access to their given service upon failure of a payment of incurred costs or suspend access to their given service upon repeated failures of a payment of incurred costs. Within an embodiment of the invention a segment may contain a service provider, or in other embodiments where a certain segment might be integral to the nature of the transaction whilst being the property of the service provider or being open source but developed by the service provide. The service provider involvement in the TPr via the segment would be to ensure that access to another service, access to it's service by third-parties or the access to its provided service by the user is allowed, interrupted, interrupted till a predetermined condition is met, denied or removed from the concerned TPr. Within other embodiments the service provider inclusion may be related to insuring the state and maintenance of:
the security, integrity and compliance of the segments involved in the TPr or the security;
the integrity and compliance of the segments involved in a TPr compliant to a specific protocol or standard environment;
a fraud prevention system within the TPr;
contingencies in the occurrence or anticipation of a loss-of-data;
physical operability of devices participating in the TPr; and
state of payment or payment of dues owed by a party consuming the provided service.

Specific details are given in the above description to provide a thorough understanding of the embodiments. However, it is understood that the embodiments may be practiced without these specific details or with variants. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units, for example processor(s) and/or coprocessor(s), may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method of authorizing a financial transaction comprising:
establishing via a remote server connected to a communications network the presence of an authorizer of the financial transaction (FT) within a predetermined threshold with respect to a geolocation associated with a requester of the financial transaction; wherein
the financial transaction comprises at least one transaction process (TPr); and
at least one of:
the authorizer is associated with a device connected to the communications network may be a requestee seeking to perform the financial transaction or a requested seeking to establish authorization of the financial transaction; and
the authorizer associated with the device connected to the communications network may be a requestee seeking to establish authorization the financial transaction or a requested seeking to perform the financial transaction.

2. (canceled)

3. The method according to claim 1, wherein
either:
authorizing the financial transaction is performed at a remote system absent direct communications between a requesting device and an authorizing device based upon establishing at least a match between an identity of a plurality of identities each relating to an authorized system within a predetermined geolocation threshold of a current geolocation of the requesting device and an identity of the requesting device relating to an financial transaction with respect to a geolocation associated with a requester of the financial transaction;
or
authorizing the financial transaction is based upon establishing via a remote server the presence of an authorizer of the financial transaction within a predetermined threshold with respect to a geolocation associated with a requester of the financial transaction where the geolocation is established for at least one of the authorizer and the requester in dependence upon verifying that acquired image content provided by the at least one of the authorizer and the requester is associated with the geolocation.

4. (canceled)

5. The method according to claim 1, wherein
a device associated with the user may act as at least one of a requesting party (TRP), an accepting party (TAP), a managing party (TMP, and a monetary beneficiary party (TMBP) in order to provide required financial information (FI) to the FT wherein the user and/or device may execute a dedicated function associated with the device in order to provide the FI to the FT;
the device may automatically execute a process for the transfer of FI to a FT as the result of the user entering a defined geolocation that has been associated with a user's previous FIs by the user or through one or more ML processes.

6. The method according to claim 1, wherein
the device automatically provides the required financial information (FI) for the FT and delegates generation of the FI to underlying software which at least one of:
fetches the FI from a secure element (SecE1);
fetches the FI from a requesting device (RD), and
fetches a tokenized representation of the financial information; and
provide instructions to a FI processing network which houses the TRP and TMBP's FI to process the transaction by providing this network with user credentials to properly identify the parties involved.

7. The method according to claim 1, wherein
the user (the requestee) through at least one of another individual, a representative of the user, or a device authorised to act on behalf of the user perform different tasks selected from the group comprising:
request from another user of the system (henceforth referred to as the requested) to pay for a good or service;
request that another device associated with the requested pay for a good or service;
request to obtain a good or service from the requestee;
request data from the requested via a transaction process; and
request data from both the requestee and requested via a transaction process.

8. (canceled)

9. The method according to claim 1, wherein
at least one of:
a requestee may dedicate or delegate some features and functions to a coprocessor unit (CoPU) which may form part of a peripheral device, an additional device, an additional merchant network device, a remote network, a server either on a remote network or within a local area network (LAN), a device with dedicated TPr, and a machine learning (ML) process;
the requestee or requested may permit transactional functions to be executable from devices which have undertaken an authentication process comprising at least one of location based authentication (LAuth) and user authentication (UAuth);
electronic devices associated with at least one of the requestee and contain pre-installed or installed identifiable credentials which are used to validate their network-dependent and medium-based transactions;
a requestee whilst being connected to an overseeing service-specific network which provides higher-order methods of analysis or control of the interfaced networks with merchant-specific metrics which allowed the merchant to monitor their merchant's area of business (MAB) whilst either being involved in the various TPr's that constitute the merchant's network of devices over all of it's locations and within the TPr of used features of the invention or communicating directly with some, or all of the devices that constitutes the merchant's network;
a requestee may perform a FT by allowing or designating a FT authorization process to be available to a customer when the customer wishes to leave the area of business or the requestee desires to settle an invoice or bill payment for example such that the customer may be present or not present within a merchant's area of business upon completion of the FT; and
the merchant in dependence upon the type of request at least one of:
empowers the requested's device to be the TAP in the TPr;
defines one of its devices to be the TAP when the requested's device has poor connectivity to the communications network; and
defines one of its devices to be the TAP when the requested's device cannot or will not assume the role of the TAP.

10-12. (canceled)

13. The method according to claim 1, wherein
either:
a requested performs a secondary UAuth which is prompted on their device from a command issued by a requestee in order to complete the TPr wherein:
the requested device is presented with a partially completed, or fully completed, TPr form in order to complete the UAuth; and
the requested (e.g. customer) is presented with the transaction form which requires it to specify selections and options which will determine the TPr of the transaction, from which the process proceeds thereafter;
or
a requested or requestee provides a means of allowing the customers to identify its area of business by either
providing devices and mechanisms to facilitate LAuth methods which would allow for LAuth to be performed by customer devices; or
providing a listing of it's location(s) by at least one of a local source of data (LSD), a remote source of data (RSD), and a nearby source of data (NSD); wherein
the means may be implemented by a merchant device.

14. (canceled)

15. The method according to method 1, wherein
at least one of:
the location of a device within a financial transaction may be obtained exploiting non-device elements or devices within a location to provide a greater degree of location accuracy or aid in maximizing the authentication and identification factors; wherein
said non-device elements or devices may be employed to update the customer device with information concerning its immediate proximity of the device within a location;
said non-device elements may be selected from the group comprising graphics markers or patterns within the location which when scanned, recorded, or captured provide this additional information;
said non-device elements are selected from the group comprising landmarks, points of interest nearby, points of interest around the location, images, and tagged geolocation data;
said devices providing improved location accuracy may include beacons or short-range transmitters which repeatedly broadcast or are paired to the customer's device; and
said non-device elements or devices may also provide directly or in association with other graphic markers or devices other LAuth and Identification methods; and
cameras or other devices are employed to at least one of:
capture location data of customers;
to trigger additional information being presented to the user;
to identify customers from merchant staff;
perform UAuth on users and location employees in order to distinguish them properly by using UAuth and BD comparison methods; and
ML methodologies as well as secure cloud-based storage elements are employed in user authorisation.

16. (canceled)

17. The method according to claim 1, further comprising
prompting the user of available features, products, services, methods etc. with respect to the location;
triggering a notifying alert on the user's device interface;
interacting with the user with a financial services device (FSD) comprising an audio-visual terminal in the proximity of the user;
sending a notifying alert to the user's contact information associated with it's UAuth baseline data (BD);
executing tasks or functions according to embodiments of the invention relating to financial transactions.

18. The method according to claim 1, wherein
authorisation comprises visual UAuth and LAuth processes within a dedicated financial services device (FSD) wherein at least one of:
the FSD automatically processes user input by correlating visually captured input with the customer's interaction with the FSD; and
the FSD performs the UAuth by reading one or more of two-dimensional machine readable graphics, three-dimensional machine readable machine readable, and mathematically interpretable graphics displayed at least one of on a visual interface of the user's device and on the exterior of the user device.

19-23. (canceled)

24. The method according to claim 1, wherein
information transmitted between devices relating to the financial transaction is fragmented over multiple messages; and
the multiple messages employed at least one of:
each contain an identifier such that the original information may be reconstructed from the multiple messages due to these identifiers; and
each contain an identifier stored in at least one of a centralized system, stored within a fragmented way, stored in the same location as the fragments to which they relate, stored within a different location to the fragments to which they relate and solely within each fragment to link fragments such that a remote system only accesses or retrieves the location of the first fragment; and

25. The method according to claim 1, wherein
data or information relating to the FT is stored within a ledger-based file-system or records (ledger), wherein
at least one of:
entries are only recorded if the TPr performing the entry provides an authentication credential;
the ledger may only accept an entry submitted by a TPr through a mathematical process of evaluation; and
the ledger and a plurality of associated connected distributions of the ledger are updated simultaneously, continuously or periodically and the plurality of connected distributions can only make an entry if all connected distributions of the plurality of connected distributions accept the entry being submitted by a TPr through a mathematical process of evaluation.

26. The method according to claim 1, wherein
data or information relating to the FT is stored within a ledger-based file-system; and
at least one of:
transmitted with a separate message indicating to which transaction the data relates; and
the data or information are encrypted during at least one of in transit within the communications network, in transit in the TPr and within the ledger-based file-system wherein at least one of:
a device of origin manages the encryption key which is only accessible to it;
the information is cryptographically signed by each segment of the TPr, and
information is saved to memory, cache or ledger is cryptographically signed by the device saving it.

27. (canceled)

28. The method according to claim 1, wherein
a predetermined portion of the TPr associated with the financial transaction requires at least of:
authentication to be supplied by at least one of the initiating device of the TPr, supplied by the authorizing device of the TPr, and supplied by one or more other devices which comprise the remainder of the devices involved in the TPr;
authentication to be provided along with the information packet of the TPr is required in order to at least one of fulfill its role within the TPr; and
each segment of the communications network involved in the TPr requires a form of authentication; and
an authentication credential required for the predetermined portion of the TPr is at least one of:
a credential authorizing the processes of the devices, segments or networks which preceded it within the TPr;
a credential authorizing the processes of the devices, segments or networks which succeed it within the TPr;
authentication in the form of LAuth;
authentication in the form of UAuth; and
authentication to succeed otherwise said device, segment or network prevents the TPr from beginning or proceeding.

29. (canceled)

30. The method according to claim 1, wherein
at least one of:
a TPr associated with the financial transaction relates to at least one:
a packet of information;
a tokenized packet of information;
a form of transaction of information;
is compliant with at least one of an industry accepted protocol, industry accepted standard, national standard and an international standard, and
is subject to monitoring by a tracking or chronological log system;
fulfillment of a role of a party of the transaction may be provided by at least one of a server, a dedicated device, a merchant's dedicated device in the financial transaction, a merchant's dedicated device in performing transactions, an interface representing a merchant's goods and services in transactions which receives dedicated or regular commands from a PPI; and
a segment within a given TPr associated with the financial transaction may be a payment processor, wherein at least one of
the payment processor is compliant with an industry standard;
multiple payment processors
the payment processor are a distinct transaction that inherently determines the success or failure of the TPr it forms part of or which possible subsequent segments of the TPr that can be undertaken;
the payment processor may be at least one of a financial institution, a service provider essential to the financial transaction, a service provider non-essential to the financial transaction, an authentication service, an identity provider, and a service which is hosted by a cloud provider, a government organization, a non-profit organization, an open-source service or tool, a shipping and or logistical service, or a dispatching service.

31-32. (canceled)

33. The method according to claim 1, wherein
either:
a segment within a given TPr associated with the financial transaction may be a payment processor may employ a blockchain-like distributed consensus system;
or
a segment within a given TPr associated with the financial transaction may be a payment processor may employ a blockchain-like distributed consensus system where the distributed consensus system at least one of:
prevents a modification of prior entries once they have successfully been evaluated by the distributed consensus system,
trigger failure of the TPr,
not trigger failure of the TPr but act to instruct the managing segments of the TPr to consider other processes;
perform or execute LAuth;
perform or execute UAuth;
perform a process relating to at least one of permission, authentication and accessibility.

34. (canceled)

35. The method according to claim 1, wherein
the TPr or one or more segments of the TPr may exploit software algorithms that include at least one machine learning (ML) process of a plurality of ML processes;
the at least one ML process of a plurality of ML processes handles the financial transaction and renders a service on behalf of at least one of the requesting party and the requested party; and
the at least one machine learning (ML) process of a plurality of ML processes is supervised, partially supervised, unsupervised, autonomous, employed in an analytic role, employed in a managing role, employed in an execution role, and employed in another role.

36-37. (canceled)

38. The method according to claim 1, wherein
the financial transaction or TPr includes a service provider, the service provider inclusion ensures the state and maintenance of:
the security, integrity and compliance of the segments involved in the TPr;
the integrity and compliance of the segments involved in a TPr compliant to a specific protocol or standard environment;
a fraud prevention system within the TPr;
contingencies in the occurrence or anticipation of a loss-of-data;
physical operability of devices participating in the TPr; and
state of payment or payment of dues owed by a party consuming the provided service.

39-46. (canceled)
